(19) United States
(12) Patent Application Publication
(10) Pub. No.: US 2024/0350228 A1
(43) Pub. Date: Oct. 24, 2024

(54) FRAME FOR HOLDING A DENTAL DAM

(71) Applicant: PDS Inc., North Vancouver (CA)

(72) Inventors: Mahmoud TORABINEJAD, Laguna Niguel, CA (US); Mason A. BAHADOR, Baltimore, MD (US); Mehdi TALWERDI, North Vancouver, BC (CA); Windfield S. FISHER, Maple Ridge, BC (CA)

(73) Assignee: PDS Inc., North Vancouver, BC (CA)

(21) Appl. No.: 18/684,671

(22) PCT Filed: Sep. 1, 2022
(86) PCT No.: PCT/CA2022/051321

§ 371 Date: Feb. 17, 2024

Related U.S. Application Data
(60) Provisional application No. 63/239,787, filed on Sep. 1, 2021.

(51) Int. Cl. A61C 5/82

(52) U.S. Cl. CPC A61C 5/82

(57) ABSTRACT

A frame for a dental dam, a kit comprising the frame, and a method of accessing a patient's oral cavity during a dental procedure using the frame. A body of the frame defining two portions engaging with the dental dam at opposite sides of the body. The body is conformationally adaptable between an open configuration, where the two portions are splayed away from each other in the open configuration to spread out the dental dam, and a retracted configuration, where the two portions are drawn towards each other to fold the dental dam. The kit may have a device comprising a member suitable for biting on and elongated between an intraoral end and an extraoral end, an intraoral fitting at the intraoral end, and an aiming portion at the extraoral end that is positioned complementarily to the intraoral fitting about the member to facilitate extraoral targeting of the intraoral fitting.

### TECHNICAL FIELD

This invention relates to devices for facilitating dental procedures and, in particular, frames for dental dams.

### BACKGROUND

Dental diagnostic tools include taking a dental radiograph, commonly referred to as a dental X-ray. During root canal treatment (also known as endodontic therapy) of a patient's tooth, root canal length and the complete obturation of the root canal to its apex is confirmed using radiographs, for example.

Root canal treatment typically involves use of a dental dam, which is flexible sheet (typically made of rubber) installed around the tooth under treatment and held in place at the tooth by one or more tooth clamps. The dental dam is known to be supported outside of the patient's mouth by a dental-dam frame, which conventionally is a single-piece U-shaped metal or plastic frame attached to the dental dam proximate the outer edges of the dental dam.

Conventionally, to take a radiograph during root canal treatment of a patient's tooth, the dental-dam frame is first removed. Then a sensor holder, having installed therein an X-ray sensor, is placed in the patient's mouth in proximity to the tooth under treatment such that the X-ray sensor is positioned on the inner side of the tooth under treatment. The patient is then instructed to bite down on the sensor holder to keep the X-ray sensor in place while the dental radiograph is taken. For conventional root canal treatment, the employed sensor holder includes an extension arm that protrudes out of the patient's mouth to extraorally indicate a relative position of the X-ray sensor, the X-ray sensor generally being obscured by the dental dam and thus not visible from outside of the patient's mouth. An X-ray tube of dental radiograph equipment is placed adjacent the patient's mouth and positioned relative to the extraoral indicator. Thereafter, the dental radiograph equipment is controlled to capture the radiographic image.

However, removing the dam frame increases the risk of saliva contamination of the tooth under treatment and increases the duration of the dental procedure. Also, requiring the patient to maintain the sensor holder's position by biting down on the sensor holder when the radiograph is being taken can be of significant inconvenience and discomfort to the patient. Such inconvenience and discomfort can result in mispositioning of the X-ray sensor and/or sensor movement during capturing of the radiograph, which can lead to inaccurate radiographs that necessitate an increased number of radiographs and consequently higher radiation exposure to the patient.

An object of the invention is to address the above shortcomings.

### SUMMARY

The above shortcomings may be addressed by providing, in accordance with one aspect of the invention, an apparatus for holding a dental sensor.

The apparatus may be a sensor holder. The sensor holder may be dimensioned for receiving a dental sensor. The dental sensor may be an X-ray sensor.

The sensor holder may be removably attachable to a tooth clamp. The tooth clamp may be operable to clamp a dental dam at one or more teeth. The tooth clamp may be operable to clamp at a tooth under treatment during root canal therapy being performed on a patient.

The sensor holder may be dimensioned for positioning a received dental sensor adjacent a tooth when the sensor holder is attached to the tooth clamp disposed at the tooth.

The sensor holder may be magnetically attachable to the tooth clamp. At least one of the sensor holder and the tooth clamp may include a first magnet. The other of the sensor holder and the tooth clamp may include a magnetic material. The other of the sensor holder and the tooth clamp may include a second magnet, the first and second magnets being oriented for attracting each other when the sensor holder and the tooth clamp are attached. The tooth clamp may include the first magnet. The sensor holder may include the second magnet.

The tooth clamp may include a connection member dimensioned to removably attach to the sensor holder. The connection member may include the first magnet. The sensor holder may include a first arm dimensioned for receiving the connection member. The sensor holder may include a first arm defining a recess for receiving the connection member. The recess may be an aperture. The first arm may include the second magnet disposed at the recess.

The sensor holder and the tooth clamp may be operable to removably attach to each other while disposed on opposing sides of the dental dam. The sensor holder and the tooth clamp may be operable to removably attach to each other while disposed on opposing sides of at least a portion of the dental dam. The sensor holder and the tooth clamp may be operable to magnetically attach to each other through the dental dam. The sensor holder and the tooth clamp may be operable to magnetically attach to each other through the dental dam positioned therebetween by hingedly folding a dental-dam frame.

The sensor holder and the tooth clamp may be operable to magnetically attach to each other through the dental dam supported by the dental-dam frame and having a portion thereof positioned adjacent the tooth under treatment while the tooth clamp is clamping the dental dam at the tooth under treatment. The sensor holder and the tooth clamp may each be dimensioned for alignment of the first magnet of the tooth clamp and the second magnet of the sensor holder, the first and second magnets being on opposing sides of the portion.

The sensor holder may include a second arm projecting perpendicularly from the first arm. The second arm may project from the first arm at a first end of the first arm. The second arm may include at least one protrusion dimensioned for receiving the dental sensor. The at least one protrusion may include first and second protrusions disposed at opposing ends of the second arm. Each of the first and second protrusions may include a pair of protruding fingers.

The first arm may define a second end opposite the first end. The second magnet may be disposed on the first arm between the first and second ends of the first arm.

The sensor holder may be removably attachable to an extraoral indicator. The sensor holder may be magnetically attachable to an extraoral indicator. The extraoral indicator may be an extraoral positioning indicator for extraorally indicating the position of the received dental sensor. At least one of the sensor holder and the extraoral indicator may include a third magnet. The other of the sensor holder and the extraoral indicator may include a magnetic material. The other of the sensor holder and the extraoral indicator may include a fourth magnet, the third and fourth magnets being oriented for attracting each other when the sensor holder is positioned intraorally and the extraoral indicator is positioned extraorally in proximity to the sensor holder. The sensor holder may include the third magnet. The third magnet may be disposed at the second end of the first arm. The extraoral indicator may include the fourth magnet.

The sensor holder and the extraoral indicator may be magnetically attachable to each other when the sensor holder and the extraoral indicator are disposed on opposing sides of the patient's cheek. The sensor holder and the extraoral indicator may be magnetically attachable to each other through the cheek of the patient proximate the tooth under treatment. The sensor holder and the extraoral indicator may be dimensioned for alignment of the third magnet of the sensor holder and the fourth magnet of the extraoral indicator on opposing sides of the patient's cheek. The extraoral indicator may include a ring dimensioned for indicating the location of the dental sensor. The extraoral indicator may include a ring dimensioned for indicating the location of the tooth under treatment. The extraoral indicator may be ring-shaped.

In accordance with another aspect of the invention, there is provided a system for holding a dental sensor. The system may include a sensor holder. The system may include a tooth clamp. The system may include an extraoral indicator. The system may include a dental-dam frame. The sensor holder may be removably attachable to the tooth clamp. The extraoral indicator may be removably attachable to the sensor holder. The sensor holder may be magnetically attachable to the tooth clamp. The extraoral indicator may be magnetically attachable to the sensor holder. The dental-dam frame may include a hinge for folding the dental-dam frame. The hinge may be operable to fold the dental dam being supported by the dental-dam frame. The hinge may be operable to fold the dental dam so as to position a portion of the dental dam adjacent to the tooth clamp that is clamping the dental dam at the tooth under treatment.

In accordance with another aspect of the invention, there is provided a method of holding a dental sensor. The method may involve removably attaching a sensor holder to a tooth clamp.

Removably attaching the sensor holder to the tooth clamp may involve attaching the sensor holder dimensioned for receiving a dental sensor. Removably attaching the sensor holder to the tooth clamp may involve attaching the sensor holder dimensioned for receiving a dental sensor being an X-ray sensor.

Removably attaching the sensor holder to the tooth clamp may involve attaching the tooth clamp operable to clamp a dental dam at one or more teeth. Removably attaching the sensor holder to the tooth clamp may involve attaching the tooth clamp operable to clamp at a tooth under treatment during root canal therapy being performed on a patient.

Removably attaching the sensor holder to the tooth clamp may involve attaching the sensor holder dimensioned for positioning a received dental sensor adjacent a tooth when the sensor holder is attached to the tooth clamp disposed at the tooth.

Removably attaching the sensor holder to the tooth clamp may involve magnetically attaching the sensor holder to the tooth clamp. Magnetically attaching the sensor holder to the tooth clamp may involve attaching the sensor holder and the tooth clamp to each other when at least one of the sensor holder and the tooth clamp includes a first magnet. Magnetically attaching the sensor holder to the tooth clamp may involve attaching the sensor holder and the tooth clamp to each other when the other of the sensor holder and the tooth clamp includes a magnetic material. Magnetically attaching the sensor holder to the tooth clamp may involve attaching the sensor holder and the tooth clamp to each other when the other of the sensor holder and the tooth clamp includes a second magnet such that the first and second magnets are oriented for attracting each other when the sensor holder and the tooth clamp are attached. Magnetically attaching the sensor holder to the tooth clamp may involve attaching the sensor holder and the tooth clamp to each other when the tooth clamp includes the first magnet. Magnetically attaching the sensor holder to the tooth clamp may involve attaching the sensor holder and the tooth clamp to each other when the sensor holder includes the second magnet.

Removably attaching the sensor holder to the tooth clamp may involve attaching the sensor holder to the tooth clamp which includes a connection member dimensioned to removably attach to the sensor holder. Removably attaching the sensor holder to the tooth clamp may involve attaching the sensor holder when the connection member includes the first magnet. Removably attaching the sensor holder to the tooth clamp may involve attaching the sensor holder when the sensor holder includes a first arm dimensioned for receiving the connection member. Removably attaching the sensor holder to the tooth clamp may involve attaching the sensor holder when the sensor holder includes a first arm defining a recess for receiving the connection member. Removably attaching the sensor holder to the tooth clamp may involve attaching the sensor holder when the recess is an aperture. Removably attaching the sensor holder to the tooth clamp may involve attaching the sensor holder when the first arm includes the second magnet disposed at the recess.

Removably attaching the sensor holder to the tooth clamp may involve attaching the sensor holder and the tooth clamp to each other while disposed on opposing sides of the dental dam. Removably attaching the sensor holder to the tooth clamp may involve attaching the sensor holder and the tooth clamp to each other while disposed on opposing sides of at least a portion of the dental dam. Removably attaching the sensor holder to the tooth clamp may involve magnetically attaching the sensor holder and the tooth clamp to each other through the dental dam. Magnetically attaching the sensor holder and the tooth clamp to each other through the dental dam may involve positioning the dental dam between the sensor holder and the tooth clamp. Positioning the dental dam between the sensor holder and the tooth clamp may involve hingedly folding a dental-dam frame attached to the dental dam.

Magnetically attaching the sensor holder and the tooth clamp to each other through the dental dam may involve attaching through the dental dam supported by the dental-dam frame and having a portion thereof positioned adjacent the tooth under treatment while the tooth clamp is clamping the dental dam at the tooth under treatment. Magnetically attaching the sensor holder and the tooth clamp to each other through the dental dam may involve attaching when the sensor holder and the tooth clamp are each dimensioned for alignment of the first magnet of the tooth clamp and the second magnet of the sensor holder and when the first and second magnets are on opposing sides of the portion.

Removably attaching the sensor holder to the tooth clamp may involve attaching when the sensor holder includes a second arm projecting perpendicularly from the first arm. Removably attaching the sensor holder to the tooth clamp may involve attaching when the second arm projects from the first arm at a first end of the first arm. Removably attaching the sensor holder to the tooth clamp may involve attaching when the second arm includes at least one protrusion dimensioned for receiving the dental sensor. Removably attaching the sensor holder to the tooth clamp may involve attaching when the at least one protrusion includes first and second protrusions disposed at opposing ends of the second arm. Removably attaching the sensor holder to the tooth clamp may involve attaching when each of the first and second protrusions includes a pair of protruding fingers.

Removably attaching the sensor holder to the tooth clamp may involve attaching when the first arm defines a second end opposite the first end. Removably attaching the sensor holder to the tooth clamp may involve attaching when the second magnet is disposed on the first arm between the first and second ends of the first arm.

The method may further involve removably attaching an extraoral indicator to the sensor holder. Removably attaching the extraoral indicator to the sensor holder may involve magnetically attaching the extraoral indicator to the sensor holder. Removably attaching the extraoral indicator to the sensor holder may involve attaching the extraoral indicator being an extraoral positioning indicator for extraorally indicating the position of the received dental sensor. Removably attaching the extraoral indicator to the sensor holder may involve attaching when at least one of the sensor holder and the extraoral indicator includes a third magnet. Removably attaching the extraoral indicator to the sensor holder may involve attaching when the other of the sensor holder and the extraoral indicator includes a magnetic material. Removably attaching the extraoral indicator to the sensor holder may involve attaching when the other of the sensor holder and the extraoral indicator includes a fourth magnet such that the third and fourth magnets are oriented for attracting each other when the sensor holder is positioned intraorally and the extraoral indicator is positioned extraorally in proximity to the sensor holder. Removably attaching the extraoral indicator to the sensor holder may involve attaching when the sensor holder includes the third magnet. Removably attaching the extraoral indicator to the sensor holder may involve attaching when the third magnet is disposed at the second end of the first arm. Removably attaching the extraoral indicator to the sensor holder may involve attaching when the extraoral indicator includes the fourth magnet.

Magnetically attaching the extraoral indicator to the sensor holder may involve attaching when the sensor holder and the extraoral indicator are disposed on opposing sides of a patient's cheek. Magnetically attaching the extraoral indicator to the sensor holder may involve attaching through the cheek of the patient proximate the tooth under treatment. Magnetically attaching the extraoral indicator to the sensor holder may involve attaching when the sensor holder and the extraoral indicator are dimensioned for alignment of the third magnet of the sensor holder and the fourth magnet of the extraoral indicator on opposing sides of the patient's cheek. Removably attaching the extraoral indicator to the sensor holder may involve attaching the extraoral indicator which includes a ring dimensioned for indicating the location of the dental sensor. Removably attaching the extraoral indicator to the sensor holder may involve attaching the extraoral indicator which includes a ring dimensioned for indicating the location of the tooth under treatment. Removably attaching the extraoral indicator to the sensor holder may involve attaching the extraoral indicator which is ring-shaped.

The method may involve folding a dental-dam frame at a hinge thereof. Folding the dental-dam frame at a hinge thereof may involve folding the dental-dam frame so as to expose a patient's mouth at an inner side of a tooth under treatment during a root canal therapy. Folding the dental-dam frame at a hinge thereof may involve folding the dental-dam frame so as to position a dental dam supported by the dental-dam frame adjacent a tooth clamp disposed at the tooth under treatment. Folding the dental-dam frame at a hinge thereof may involve positioning a portion of the dental dam adjacent the tooth clamp that is clamping the dental dam to the tooth under treatment.

The method may involve removably attaching the sensor holder to the tooth clamp through the portion of the dental dam adjacent the tooth clamp. Removably attaching the sensor holder to the tooth clamp through the portion of the dental dam adjacent the tooth clamp may involve magnetically attaching the sensor holder and the tooth clamp to each other through the dental-dam portion. Magnetically attaching the sensor holder and the tooth clamp to each other through the portion may involve bringing the second magnet of the sensor holder into proximity with the first magnet of the tooth clamp while on opposing sides of the dental-dam portion.

The method may involve removably attaching the extraoral indicator to the sensor holder. Removably attaching the extraoral indicator to the sensor holder may involve magnetically attaching the extraoral indicator to the sensor holder through the cheek of the patient proximate the dental sensor. Removably attaching the extraoral indicator to the sensor holder may involve magnetically attaching the extraoral indicator to the sensor holder through the cheek of the patient proximate the tooth under treatment. Magnetically attaching the extraoral indicator to the sensor holder through the cheek of the patient proximate the tooth under treatment may involve bringing the fourth magnet of the extraoral indicator into proximity with the third magnet of the sensor holder while the sensor holder and the extraoral indicator are on opposing sides of the patient's cheek. Magnetically attaching the extraoral indicator to the sensor holder through the cheek of the patient proximate the tooth under treatment may involve bringing the magnetic extraoral indicator into proximity with the third magnet of the sensor holder while the sensor holder and the extraoral indicator are on opposing sides of the patient's cheek.

In some aspects, the disclosure describes an apparatus for dental imaging, comprising: at least one magnet; and an arm coupled to a sensor via the at least one magnet, the arm configured to be held when engaged with the sensor to hold the sensor in an intraoral position.

In some aspects, the arm may be configured to be bit when engaged with the sensor to hold the sensor in an intraoral position.

In some aspects, the arm may define a channel for routing therethrough wiring or tubing to supply an intraoral space.

In some aspects, the arm may include at least two magnets defining two engagement positions for the sensor.

In some aspects, the sensor may couple to the arm via a sensor holder, the sensor holder including at least two magnets defining two engagement positions of the sensor.

In some aspects, the sensor may be coupled to the sensor via the at least one magnet to allow rotation of the sensor relative to the arm.

In some aspects, the arm may include lights to provide illumination in an intraoral space.

In some aspects, the disclosure describes an apparatus for dental imaging, comprising: an arm coupled to a sensor; and a bite coupled to the arm to hold the sensor in an intraoral position by a patient, the bite movably engaged with the arm to define a biting position adapted to the patient.

In some aspects, the arm may be magnetically coupled to the sensor via an assembly of magnets.

In some aspects, the assembly of magnets may include two spaced apart magnets connected to each other for co-rotation via a connecting rod.

In some aspects, the assembly of magnets may include a pair of magnets coupled together via a connecting rod extending across on opposite sides a rail, the bite engaged with the rail for linear motion.

In some aspects, the assembly of magnets may allow relative rotation of the sensor and the arm.

In some aspects, the apparatus may further comprise a target coupled to the arm via a cross arm, the cross arm substantially lateral to the target and the cross arm.

In some aspects, the target may be movably engaged with the cross arm.

In some aspects, the disclosure describes a frame for (e.g. at least partially) retaining a dental dam around a patient's mouth, the frame comprising: a first leg to retain a first portion of the dental dam around (and/or over) the patient's mouth; and a second leg rotatably coupled to the first leg (around the patient's mouth, e.g. via a bridge) to retain around (and/or over) the patient's mouth a second portion of the dental dam different than the first portion, the second leg configured to retract the second portion away from the patient's mouth by rotating relative to the first leg.

In some aspects, the frame further comprises a bridge rotatably coupling the second leg to the first leg, each of the first leg and the second leg separately rotatably coupled to the bridge to allow relative rotation between the first leg and the second leg.

In some aspects, the frame includes a raised portion for accommodating the patient's face underneath the raised portion. In some aspects, the first leg and the second leg each have respective raised portion together defining the raised portion. In some aspects, the first leg is coupled to the second leg via a bridge forming the raised portion. In some aspects, the raised portion is an arcuate portion adapted to fit over the patient's chin.

In some aspects, the first leg and the second leg include protrusions for engaging with the dental dam on opposite sides of the patient's mouth to cover the patient's mouth. In some aspects, the protrusions are oriented to engage with the dental dam to generate reacting torque using tension in the dental dam for countering rotation of the first leg and second relative to each other. In some aspects, the protrusions extend from the first leg and the second leg along the patient's face. In some aspects, the protrusions extend towards a patient's face.

In some aspects, the second leg (and/or first leg) is configured to be rotatable relative to the first leg (and/or second leg, respectively) in a direction away from the dental dam to hinder rotation while the dental dam is engaged with the second leg (and/or first leg, respectively). In some aspects, the dental dam is disposed between the patient's face and the frame and the second leg is rotatable away from the patient's face.

In some aspects, the frame further comprises a locking mechanism to prevent rotation of the legs.

In some aspects, one or more of apparatuses for dental imaging described herein may further comprise the frame, wherein the second leg of the frame is configured to allow passage of the sensor coupled to the arm into the patient's mouth when the second leg is rotated to retract the second portion away from the patient's mouth. In some examples, the second portion is coupled to the second leg and is adapted and/or dimensioned, accordingly.

In some aspects, the disclosure describes a method of sensor placement for intraoral dental imaging during dental treatment of a patient, comprising: retaining a dental dam around the patient's mouth using a frame; while retaining the dental dam around the patient's mouth, partially uncovering the patient's mouth by rotating a leg of the frame away from the patient's mouth to partially retract the dental dam to receive a sensor into the patient's mouth; and holding a sensor inside the patient's mouth using an arm coupled to the sensor.

In some aspects, the arm is magnetically coupled to the sensor.

In some aspects, holding the sensor inside the patient's mouth using the arm includes causing the patient to bite down on a bite movably engaged with the arm to define a biting position adapted to the patient.

In an aspect, the disclosure describes a frame for a dental dam. The frame also includes a body defining two portions configured to engage with the dental dam and that are situated at opposite sides of the body, the body being conformationally adaptable between an open configuration and a retracted configuration such that the two portions are splayed away from each other in the open configuration to spread out the dental dam and are drawn towards each other in the retracted configuration to fold the dental dam.

Implementations may include one or more of the following features. The frame wherein the body is elongated between the opposite sides from a first terminal end to a second terminal end, the second terminal end spaced apart from the first terminal end. The first portion is a first piece defining the first terminal end and attached to a first part of the dental dam, and the second portion is a second piece defining the second terminal end and attached to a second part of the dental dam, a hinge of the body coupling the first piece to the second piece to allow rotation of the first and second pieces relative to each other to allow retraction of the first and second parts of the dental dam over each other. The body includes a detent selectively engageable with the hinge to prevent rotation of the first and second pieces relative to each other. The detent is slidably engageable with the first piece to at least partially girdle the hinge to obstruct rotation of the first and second pieces about the hinge.

In an aspect, the disclosure describes a kit for use in a dental procedure to facilitate intraprocedural access to a patient's oral cavity. The kit also includes: a frame for a dental dam, substantially as set out above, being mounted over the oral cavity such that the open configuration is suitable to hinder access to the oral cavity and the retracted configuration is suitable to allow access to the oral cavity.

Implementations may include one or more of the following features. The kit includes device having a member suitable for biting by teeth and elongated between an intraoral end and an extraoral end; an intraoral fitting at the intraoral end; and an aiming portion at the extraoral end that is positioned complementarily to the intraoral fitting about the member to facilitate extraoral targeting of the intraoral fitting. The member is substantially linear, and the aiming portion is shaped to extend at least partially laterally from the member to define a reference plane and a reference locus in the reference plane such that a ray defined by the reference plane and the reference locus traverses the intraoral fitting. The aiming portion is an aiming piece slidably engaged with the member to allow selective extraoral positioning, relative to the intraoral fitting, of the aiming portion along the ray. The member defines two intraoral attachment portions, the intraoral fitting being removably attachable to any one of the two intraoral attachment portions to selectively facilitate extraoral location of the intraoral fitting through right and left facial sides. The intraoral attachment portions are configured to couple to the intraoral fitting via interference fits. The intraoral fitting includes a sensor holder and a sensor for dental imaging removably attached to the sensor holder. The two portions include a first portion attached to a first part of the dental dam and a second portion attached to a second part of the dental dam, the first and second portions attached to each other via an intermediate portion disposed between the first and second portions, the first and second portions being independently rotatable relative to the intermediate portion to permit the first and second parts of the dental dam to be selectively retracted towards each other. The first portion is a first piece, the second portion is a second piece, and the intermediate portion is an intermediate piece, the first and second pieces being hinged at opposed ends of the intermediate portion to allow independent rotation of each of the first and second pieces about the intermediate piece. The frame includes a first detent selectively engageable with a first hinge hinging the first piece to the intermediate piece to prevent rotation of the first and intermediate pieces about the first hinge, and a second detent selectively engageable with a second hinge hinging the second piece to the intermediate piece to prevent rotation of the second and intermediate pieces about the second hinge. The first and second portions extend in a common plane and connect to each other in a plane that is offset from the common plane to facilitate fitting of the frame. The body includes a plurality of spikes extending outwardly therefrom to pierce and frictionally engage with the dental dam.

In an aspect, the disclosure describes a method of accessing a patient's oral cavity during a dental procedure. The method also includes (a) positioning a frame for a dental dam on the patient, a body of the frame being conformationally adaptable between open and retracted configurations, two portions of the body, situated at opposite sides of the body and engaged with the dental dam to facilitate the dental procedure, being splayed away from each other in the open configuration to spread out the dental dam to hinder access to the oral cavity; and (b) adapting the body frame from the open configuration to the retracted configuration to draw the two portions towards each other to fold the dental dam to allow access to the oral cavity.

Implementations may include one or more of the following features. The method further comprising anchoring the dental dam in the oral cavity, wherein step (b) is executed while the dental dam is anchored in the oral cavity. The method further comprising: (c) after step (b), disposing a member suitable for biting by teeth in the oral cavity such that the member is held in-place at least partially in the oral cavity, the member elongated between intraoral and extraoral ends; and (d) after step (c), targeting, extraorally, electromagnetic radiation at a sensor held at the intraoral end by using an aiming portion at the extraoral end positioned complementarily to the sensor about the member. The body is elongated between the opposite sides from a first terminal end to a second terminal end, the second terminal end spaced apart from the first terminal end. The first portion is a first piece defining the first terminal end and attached to a first part of the dental dam, and the second portion is a second piece defining the second terminal end and attached to a second part of the dental dam, the method further comprising: rotating the first and second pieces relative to each other via a hinge of the body coupling the first piece to the second piece to retract the first part of the dental dam towards the second part of the dental dam to allow access to the oral cavity. The method further comprising: engaging a detent with the hinge to prevent rotation of the first and second pieces relative to each other. The detent is slidably engageable with the first piece to at least partially girdle the hinge to obstruct rotation of the first and second pieces about the hinge. The two portions include a first piece attached to a first part of the dental dam and a second piece attached to a second part of the dental dam, the first and second pieces independently hinged to an intermediate piece disposed between the first and second portions to permit the first and second parts of the dental dam to be selectively retracted towards each other, the method further comprising: engaging a first detent with a first hinge coupling the first piece to the intermediate piece to prevent rotation of the first and intermediate pieces relative to each other; and while the first detent is engaged with the first hinge, rotating the second piece relative to the intermediate piece to retract the second part of the dental dam towards the first part of the dental dam to allow access to the oral cavity. The method further comprising: rotating the second piece relative to the intermediate piece to draw the second part of the dental dam away from the first part of the dental to hinder access to the oral cavity; and engaging a second detent with a second hinge coupling the second piece to the intermediate piece to prevent rotation of the second and intermediate pieces relative to each other. The first and second portions extend in a common plane and connect to each other in a plane that is offset from the common plane to facilitate fitting of the frame. The body includes a plurality of spikes extending outwardly therefrom to pierce and frictionally engage with the dental dam.

Embodiments may include one or more of the features described above.

The foregoing summary is illustrative only and is not intended to be in any way limiting. Further details of these and other aspects of the subject matter of this application will be apparent from the detailed description included below and the drawings.

### DESCRIPTION OF THE DRAWINGS

Reference is now made to the accompanying drawings, in which:

FIG. 1 is a top and side view of a dental-dam frame having a hinge according to a first embodiment of the invention;

FIG. 2 is a perspective view of a tooth clamp having a first magnet according to the first embodiment of the invention;

FIG. 3 is a perspective view of the tooth clamp shown in FIG. 2, showing the tooth clamp clamped to a mock tooth;

FIG. 4 is a perspective view of a sensor holder having a second magnet according to the first embodiment of the invention;

FIG. 5 is a perspective view of the sensor holder shown in FIG. 4 removably attached to the tooth clamp shown in FIG. 2, showing a third magnet of the sensor holder;

FIG. 6 is a perspective view of a sensor holder according to a second embodiment of the invention removably attached to the tooth clamp shown in FIG. 2, showing a second-embodiment third magnet;

FIG. 7 is a perspective view of the sensor holder shown in FIG. 6 attached to the tooth clamp shown in FIG. 6, showing the second-embodiment third magnet;

FIG. 8 is a perspective view of an extraoral indicator magnetically attached to the third magnet shown in FIG. 7;

FIG. 9 is a flow diagram showing a method of holding a dental sensor in accordance with embodiments of the invention;

FIG. 10A is a perspective view of a frame for retaining a dental dam around a patient's mouth in a locked position, in accordance with an embodiment;

FIG. 10B is a perspective view of the frame in an unlocked position;

FIG. 10C is a perspective view of the frame in folded (and unlocked) position;

FIG. 10D is an enlarged view of region 10D in FIG. 10A, showing a locking mechanism for the frame;

FIG. 10E is an enlarged view of region 10E in FIG. 10B, showing the locking mechanism;

FIG. 10F is an enlarged view of region 10F in FIG. 10C, showing the locking mechanism;

FIG. 10G is an enlarged view of region 10G in FIG. 10B, showing a protrusion;

FIG. 11A is a perspective view of a frame for retaining a dental dam around a patient's mouth, in accordance with another embodiment;

FIG. 11B is a perspective view of the frame in a folded position;

FIG. 12 is a perspective view of the frame, showing a locking mechanism of the frame;

FIG. 13 is a perspective view of a frame for retaining a dental dam around a patient's mouth, in accordance with yet another embodiment;

FIG. 14 is a perspective view of a frame for retaining a dental dam around a patient's mouth, in accordance with a further embodiment;

FIG. 15A is an enlarged bottom plan view of the frame, showing an embodiment of a locking mechanism in an unlocked position;

FIG. 15B is an enlarged bottom plan view of the frame, showing the locking mechanism in a locked position;

FIG. 16A is an enlarged bottom plan view of the frame, showing another embodiment of a locking mechanism in an unlocked position;

FIG. 16B is an enlarged bottom plan view of the frame, showing the locking mechanism in an intermediate position between locked and unlocked;

FIG. 16C is an enlarged bottom plan view of the frame, showing the locking mechanism in a locked position;

FIG. 17A is a perspective view of a frame for retaining a dental dam around a patient's mouth, in accordance with yet another embodiment;

FIG. 17B is a perspective view of the frame in a folded position;

FIG. 18A is a front elevation view of a locking mechanism for the frame, in accordance with an embodiment;

FIG. 18B is a partial (enlarged) front elevation view of the frame with the locking mechanism installed;

FIG. 19A is a perspective view of a frame for retaining a dental dam around a patient's mouth, in accordance with further embodiment;

FIG. 19B is a front elevation view of the frame, in an unfolded position;

FIG. 19C is a front elevation view of the frame, in a folded position;

FIG. 20A is a perspective view of an apparatus for dental imaging, in accordance with an embodiment, and showing a sensor in a first position;

FIG. 20B is a perspective view of the apparatus, showing a sensor in a second position;

FIG. 20C is a perspective view of the apparatus, showing a sensor in a third position;

FIG. 21A is a perspective view of a sensor holder, in accordance with an embodiment;

FIG. 21B is a perspective view of the sensor with a sensor engaged therein;

FIG. 22A is a plan view of the sensor holder, showing positions of embedded magnets;

FIG. 22B is a plan view of the arm of the apparatus, showing a position of an embedded magnet;

FIG. 23A is a perspective view of an apparatus for dental imaging, in accordance with an embodiment;

FIG. 23B is a perspective view of the apparatus equipped with a sensor;

FIG. 24A is a rear perspective view of an arm of the apparatus;

FIG. 24B is a front perspective view of the arm;

FIG. 25A is a perspective view of the arm showing locations of embedded magnets;

FIG. 25B is a perspective view of the sensor holder showing a location of an embedded magnet;

FIG. 26 is a perspective view of an apparatus for dental imaging, in accordance with an embodiment;

FIG. 27 is another perspective view of the apparatus;

FIG. 28A is a front elevation view of the apparatus, showing the sensor magnetically engaged with a bite arm;

FIG. 28B is a rear elevation view of the apparatus, showing the bite arm magnetically engaged with the cross-arm;

FIG. 29 is a back view of a sensor engaged with a magnet strap, in accordance with an embodiment;

FIG. 30 is a flow chart of an exemplary method of sensor placement for intraoral dental imaging during dental treatment of a patient;

FIG. 31A is a perspective view of frame for a dental dam in an open configuration, in accordance with an embodiment;

FIG. 31B is a front elevation view of the frame as shown in FIG. 31A;

FIG. 32 is a perspective view of the frame of FIGS. 31A-31B in a first retracted configuration, in accordance with an embodiment;

FIG. 33A is a perspective view of the frame of FIGS. 31A-31B in a second retracted configuration, in accordance with an embodiment;

FIG. 33B is a front elevation view of the frame as shown in FIG. 33A;

FIG. 34A is a perspective view of the frame of FIGS. 31A-31B in an open configuration with detents engaged to keep the frame in the open configuration, in accordance with an embodiment;

FIG. 34B is a front elevation view of the frame as shown in FIG. 34A;

FIG. 35A is atop plan view of the frame of FIGS. 31A-31B engaged with a dental dam, in accordance with an embodiment;

FIG. 35B is a bottom plan view of the frame as shown in FIG. 35A;

FIG. 36A is a perspective of a device for positioning a sensor inside an oral cavity of a patient, in accordance with an embodiment;

FIG. 36B is a front elevation view of the device as shown in FIG. 36A;

FIG. 37A is a perspective of a device for positioning a sensor inside an oral cavity of a patient, in accordance with another embodiment;

FIG. 37B is a front elevation view of the device as shown in FIG. 37A;

FIG. 37C is another perspective view of the device as shown in FIG. 37A;

FIG. 38A is an enlarged perspective view of a joint of the device of FIG. 37A, in accordance with an embodiment;

FIG. 38B is an enlarged perspective view of a member of the device with a protrusion for forming the joint of FIG. 38A; and

FIG. 39 is a flow chart of an exemplary method of accessing a patient's oral cavity during a dental procedure.

### DETAILED DESCRIPTION

This disclosure describes devices for facilitating dental procedures and mechanisms for holding sensors including, to an apparatus, method and system for holding a dental sensor such as a dental X-ray sensor, and relates to mechanisms for holding liquid and particle impervious fabrics and, in particular, to an apparatus, method and system for holding a dental dam such as a dental rubber dam.

Aspects of various embodiments are described in relation to the figures.

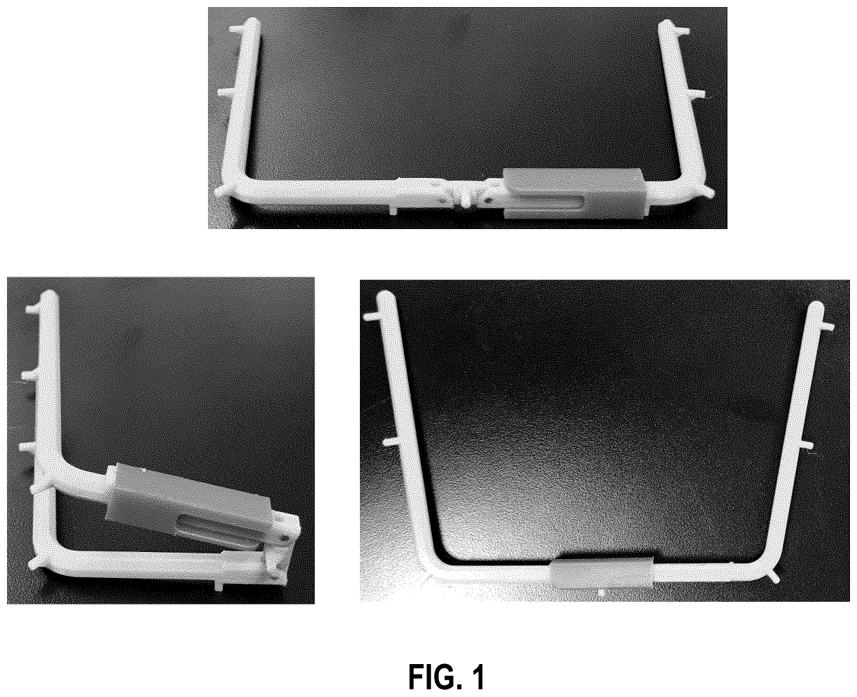

FIG. 1 is a top and side view of a dental-dam frame having a hinge according to a first embodiment of the invention.

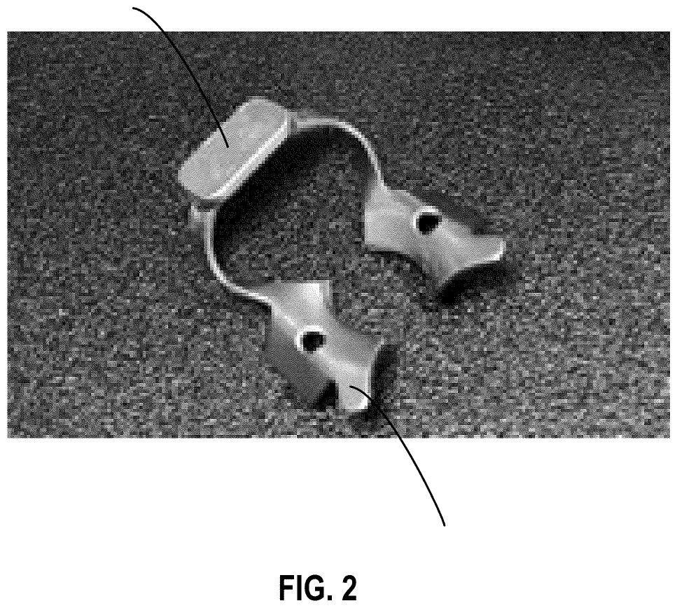

FIG. 2 is a perspective view of a tooth clamp having a first magnet according to the first embodiment of the invention.

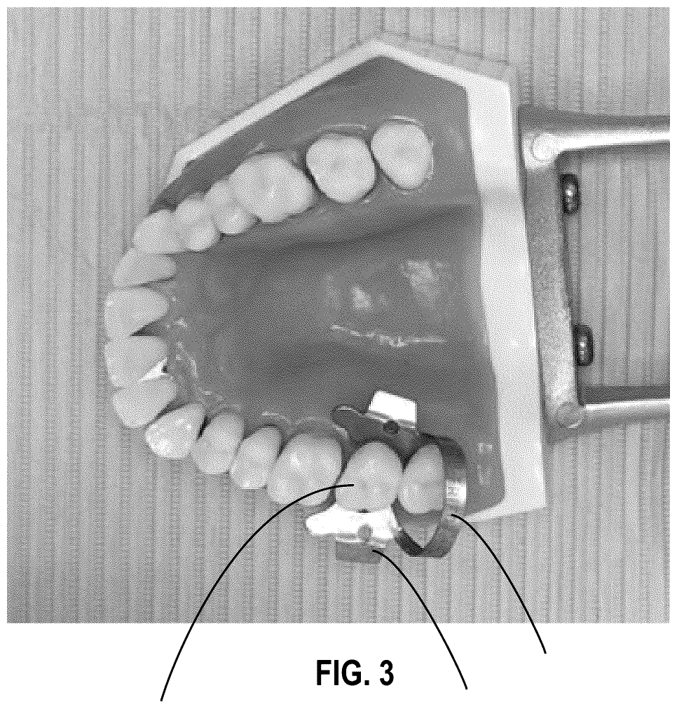

FIG. 3 is a perspective view of the tooth clamp shown in FIG. 2, showing the tooth clamp clamped to a mock tooth.

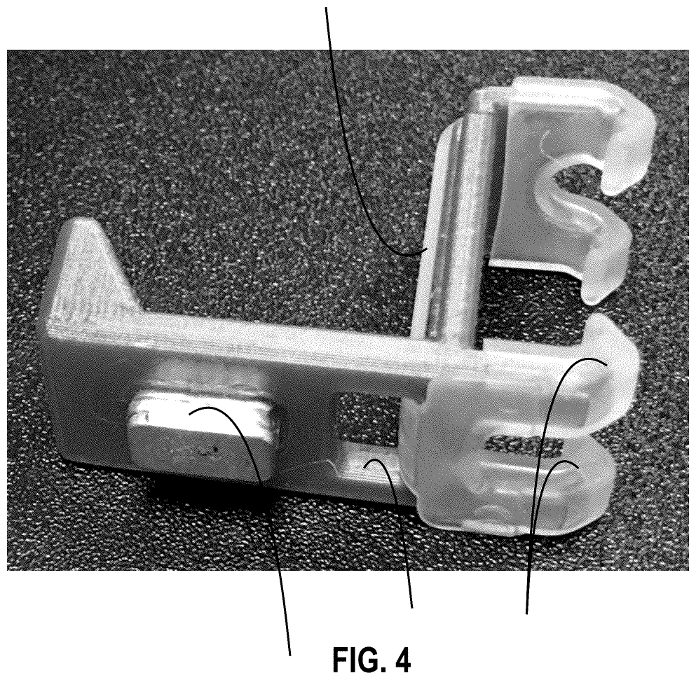

FIG. 4 is a perspective view of a sensor holder having a second magnet according to the first embodiment of the invention.

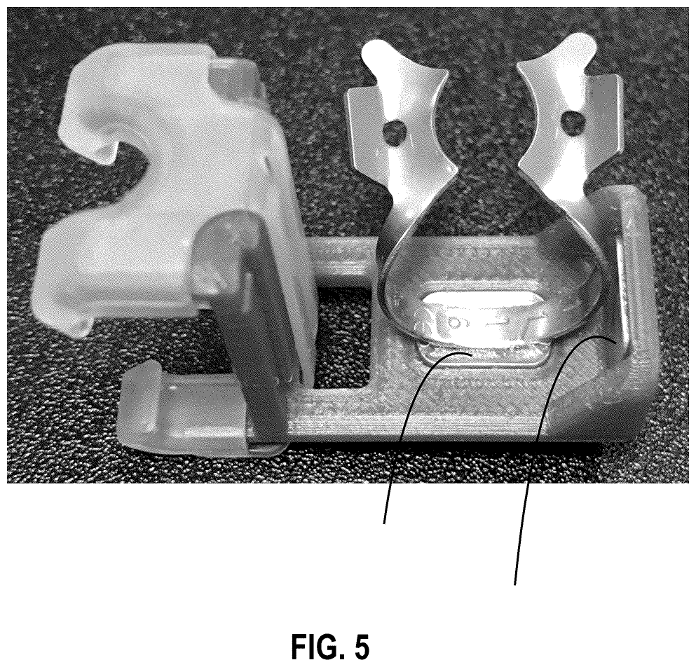

FIG. 5 is a perspective view of the sensor holder shown in FIG. 4 removably attached to the tooth clamp shown in FIG. 2, showing a third magnet of the sensor holder.

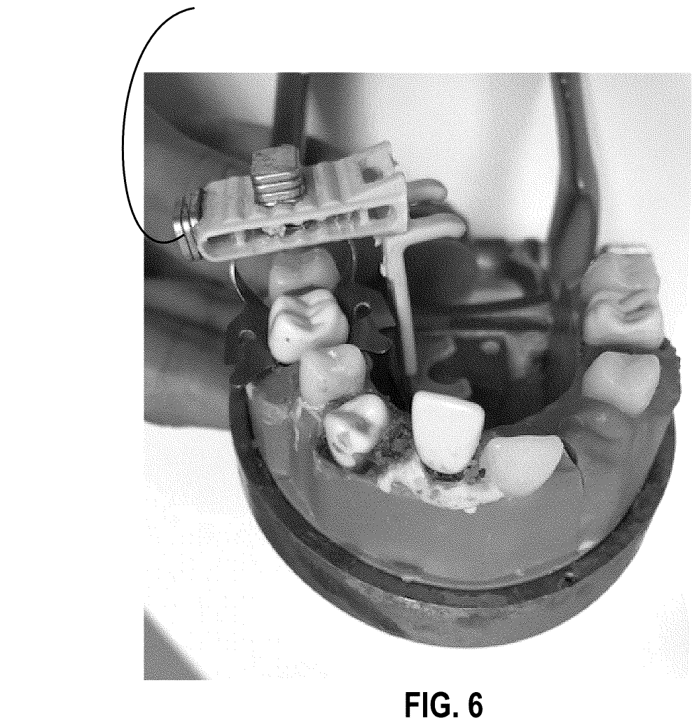

FIG. 6 is a perspective view of a sensor holder according to a second embodiment of the invention removably attached to the tooth clamp shown in FIG. 2, showing a second-embodiment third magnet.

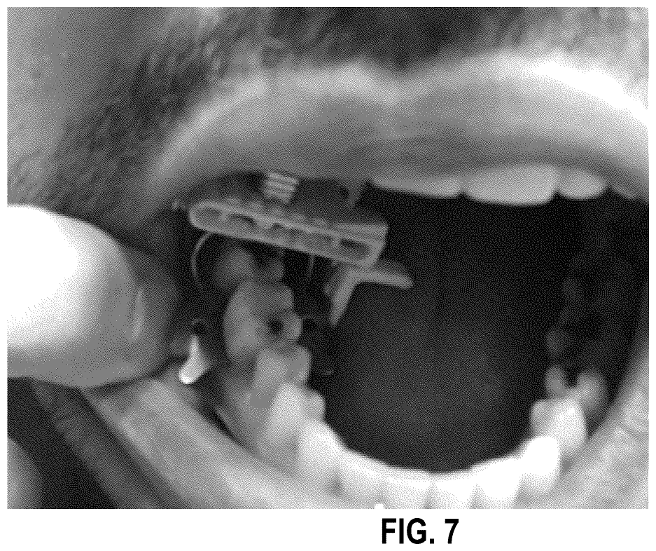

FIG. 7 is a perspective view of the sensor holder shown in FIG. 6 attached to the tooth clamp shown in FIG. 6, showing the second-embodiment third magnet.

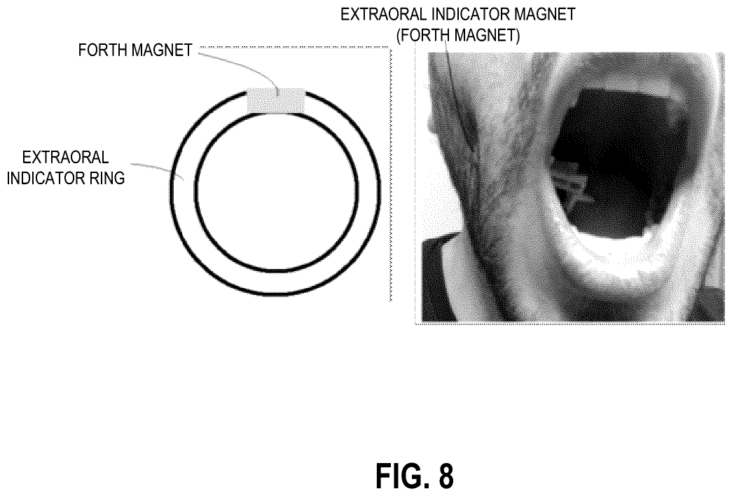

FIG. 8 is a perspective view of an extraoral indicator magnetically attached to the third magnet shown in FIG. 7.

An apparatus for holding a dental sensor includes: (a) clamping means for clamping a dental dam to a tooth; (b) support means for supporting the dental dam; (c) holding means for holding the dental sensor in an intraoral position relative to the clamping means; (d) indicator means for extraorally indicating the intraoral position.

Referring to FIGS. 1-8, the present invention comprises in various embodiments a novel and improved method to place x-ray sensors intraorally next to the tooth during root canal treatment to reduce risk of further root canal contamination and patient radiation exposure. The method utilizes a magnetic x-ray sensor holder and a magnetic tooth clamp which is placed on the tooth during root canal treatment. This novel use for placing x-ray sensor next to the tooth provides many advantages over existing methods. In the proposed embodiment, rubber dam frame has a hinge in the middle and can be folded for radiographs during root canal treatment. This eliminates the need to remove the rubber dam frame and reduces the risk of further root canal contamination. Furthermore, the magnetic sensor holder locates the magnetic tooth clamp intraorally, eliminating the operator's error in locating the right location of the tooth. The magnetic holder places and stabilizes the x-ray sensor exactly next to the tooth without relying on the patient's compliance to bite down on the sensor holder. This method reduces the risk of sensor movement and misplacement leading to more accuracy and lowers the number of radiographic attempts and consequently patient's radiation exposure. In order to align the x-ray tube with the unseen x-ray sensor inside the patient's mouth, a magnetic ring is placed extra-orally on the patient's cheek. The magnetic ring is attracted to the magnetic x-ray sensor holder inside the patient's mouth indicating the location of the x-ray sensor. This approach eliminates the need for currently used extension arms and increases patient's comfort during taking the radiographs.

As noted above, the method of the present invention involves in at least some embodiments the use of a magnetic x-ray sensor holder, a magnetic rubber dam clamp, a magnetic ring, and a foldable rubber dam frame to place the x-ray sensor intraorally during root canal treatments. This method provides a superior method to place the x-ray sensors intraorally during root canal treatment.

The magnetic rubber dam clamp in some embodiments has a magnetic part attached to its top ring (FIG. 2). The magnetic x-ray sensor holder comprises of two parts, namely, a first arm and a second arm projecting perpendicularly from the first arm. The first part has a depression with a magnet inside which houses the magnetic part of the clamp (FIG. 4). Another magnet is placed at one end of the x-ray holder which attracts the magnetic ring (FIG. 8). The second part of the x-ray sensor holder has an elastic rubber which can be stretched out to accommodate the x-ray sensor.

The second part in some embodiments includes a pair of fingered protrusions disposed at opposing ends of the second arm for receiving the X-ray sensor. In various embodiments, the distance between opposing protrusions, the size of the protrusions, the number and extent of fingers forming the protrusions, the size of the elastic rubber, the elasticity of the elastic rubber, other related dimensions, and any combination thereof, is adjustable to accommodate a variety of industry-standard sizes of X-ray sensors. Adjustability may be achieved by a telescoping or other slidable design, and may include resilience such as spring-loading. In some embodiments, a variety of differently sized X-ray sensor holders are colour-coded to indicate the type of X-ray sensor for use therewith.

The rubber dam frame has a hinge in the middle which allows the operator to fold the frame in half while taking the radiographs (FIG. 1).

Referring to FIG. 1, the frame in various embodiments is foldable over a range of angles from an acute angle of nearly zero degrees to a fully open angle of 180 degrees. The frame may include a lock for locking the frame in the fully open position (180 degrees angle). FIG. 1 shows a sliding lock. In some embodiments (not shown), the lock is operable to lock the frame at any desirable angle within a range of angles such as its full range of foldable angles. Any suitable locking mechanism may employed in various embodiments, such as the external sliding lock of FIG. 1, an internal sliding lock operable to slide within the frame, an external or internal button-actuated lock, a gear-type locking mechanism, a rolling-type lock, a threaded-engagement lock, any other suitable mechanism, or any combination thereof for example.

Before root canal treatment is started, the magnetic clamp with the rubber dam around it is placed on the tooth and the foldable frame holds the rubber dam over the patient's mouth. To take radiographs during root canal treatment, the foldable frame is folded in half to gain access to the tooth without further contaminating the root canal(s) (FIG. 1). Then, the x-ray sensor then needs to be placed exactly next to the tooth and remain steady during taking radiographs. Accordingly, the magnetic sensor holder (having installed therein an X-ray sensor) is placed on top of the magnetic clamp. Subsequently, the magnetic ring is placed extraorally on the patient's cheek. The magnetic ring is attracted to the magnetic end of the sensor holder indicating the location of unseen x-ray sensor. The x-ray tube can then be aligned with the sensor using the location of the magnetic ring and radiographs is taken. After taking the radiograph, the sensor holder and magnetic ring is removed, and the frame is folded back to its original shape. The root canal treatment is then continued without contamination of the root canal.

The magnetic tooth clamp, magnetic sensor holder, magnetic ring, and a foldable frame is useable for taking radiographs, thereby embodying in variations a novel method of placing x-ray sensors intraorally. Such improved method for placement of X-ray sensors inside patient's mouth involves in various embodiments the use of a magnetic X-ray holder and hinged rubber dam frame, which exhibits several advantages over existing methods, including elimination of x-ray sensor holder extension arm, facilitating the placement of x-ray sensor inside the patient's mouth, using magnets to hold the sensor in place instead of relying on the patient to bite down on the sensor holder, and folding the rubber dam frame instead of removing it to place the sensor inside the mouth. In at least one embodiment, the rubber dam frame is folded in the middle and the x-ray sensor is placed next to the tooth with rubber dam clamp on using magnets eliminating the need to remove the frame. A magnetic ring placed on patient's cheek is used to indicate the location of x-ray sensor inside the mouth. This method simplifies and improves taking radiographs during root canal procedures leading to better isolation and less radiation exposure for the patient by reducing the number of radiographic attempts.

The materials employed intraorally or otherwise making contact with the skin of a patient are made of medical grade materials approved for such use. The magnets in some embodiments are coated or covered with a non-magnetic material such as medical-grade plastic. In some embodiments, the coating or covering of the magnets are colour-coded according to the strength of the magnet, dimensions of the magnets, or both the strength and the dimensions of the magnets. For example, each of the third magnet and the fourth magnet may include a plurality of replaceable and/or stackable magnets such that the magnetic strength can be adjusted for optimal performance and comfort of the patient's cheek. A set of third and fourth magnets that are too weak may permit the extraoral indicator to move and/or drop; while a set of third and fourth magnets that are too strong may cause discomfort of the patient's cheek.

The described method of using a magnetic X-ray sensor holder and hinged rubber dam frame in capturing radiographs during endodontic treatment allows the practitioner to more accurately place the sensor intraorally without removing the rubber dam frame and without relying on the patient to hold the sensor in place. The described example of how the dentist or endodontist can use a magnetic sensor holder to place the x-ray sensor intraorally is illustrative, and not meant to be restrictive. Furthermore, the present invention may be utilized in other specific forms without departing from its spirit or essential characteristics.

Thus, there is provided an apparatus for holding a dental sensor, the apparatus comprising a first arm and a second arm projecting perpendicularly from the first arm, the apparatus being operable to removably attach at its first arm to a tooth clamp, the apparatus being operable to receive the dental sensor at its second arm, the apparatus further being operable to removably attach to an extraoral indicator.

### Method of Operation

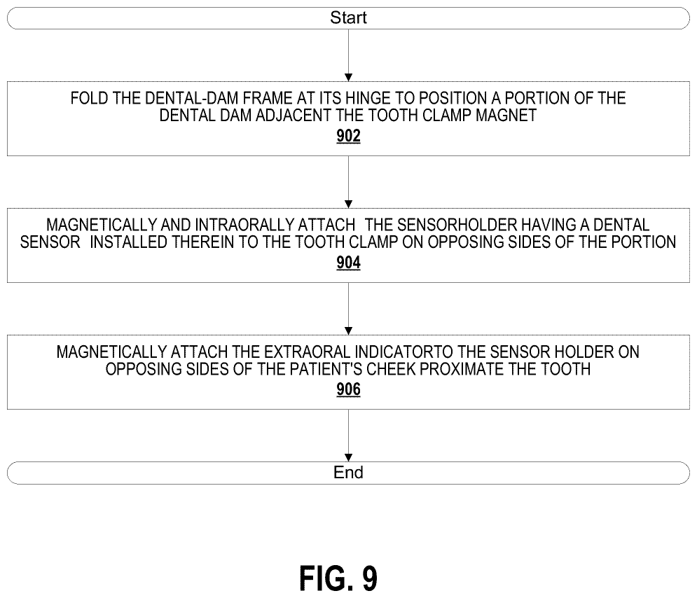

FIG. 9 is a flow diagram showing a method of holding a dental sensor in accordance with embodiments of the invention.

Referring to FIG. 9, a method of using the system in accordance with embodiments of the invention is shown.

The system in some embodiments includes one or more system components such as a foldable dental-dam frame for folding a dental dam to expose an interior of a patient's mouth; a tooth clamp for clamping a dental dam in place around a tooth under treatment; a sensor holder for holding a dental sensor, the tooth clamp and the sensor holder being removably attachable to each other on opposing sides of a portion of the dental dam; and an extraoral indicator for extraorally indicating the intraoral location of the dental sensor, the extraoral indicator and the sensor holder being removably attachable to each other on opposing sides of a patient's cheek.

The method at a first step involves folding the dental-dam frame at its hinge to position a portion of the dental dam adjacent the tooth clamp magnet when the tooth clamp is clamping the dental dam to the patient's tooth under treatment.

The method at a second step involves magnetically and intraorally attaching the sensor holder to the tooth clamp on opposing sides of the dental dam portion when the sensor holder has a dental sensor, such as an X-ray sensor, installed in the sensor holder.

The method at a third step involves magnetically attaching the extraoral indicator to the sensor holder on opposing sides of the patient's cheek proximate the tooth under treatment, thereby extraorally indicating the intraoral location of the dental sensor.

Thus, there is provided a method of holding a dental sensor, the method comprising: (a) folding a dental-dam frame to position a portion of a dental dam adjacent a tooth clamp clamping the dental dam to a tooth under treatment of a patient; (b) removably attaching a sensor holding having the dental sensor installed therein to the tooth clamp on opposing sides of the portion; and (c) removably attaching an extraoral indicator to the sensor holder on opposing sides of the patient's cheek proximate the tooth under treatment.

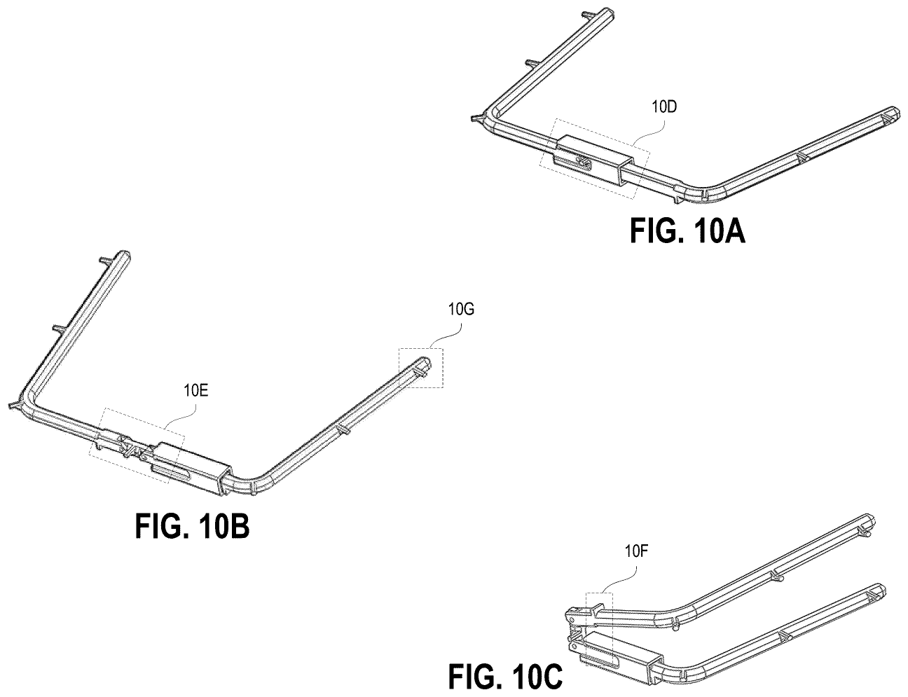

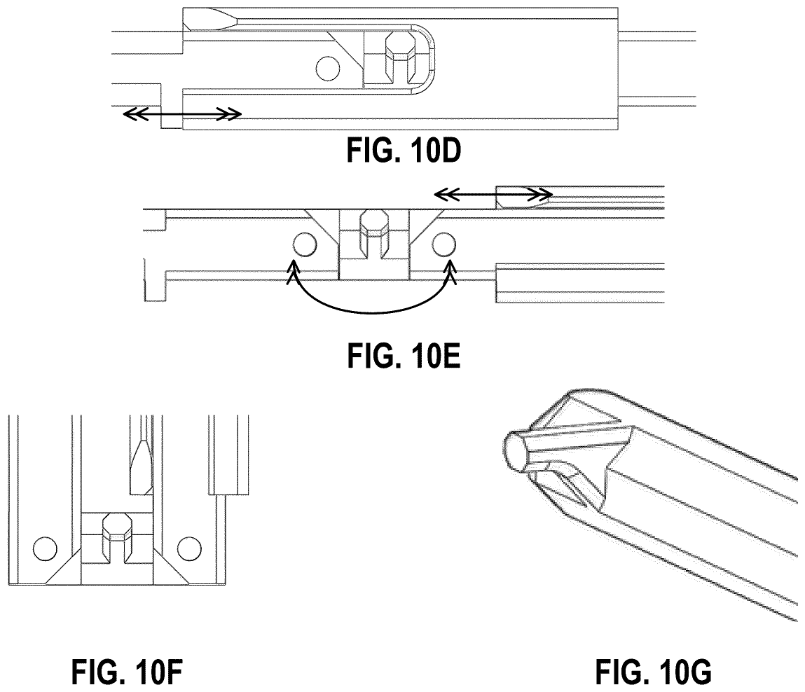

FIG. 10A is a perspective view of a frame for retaining a dental dam around a patient's mouth in a locked position, in accordance with an embodiment.

FIG. 10B is a perspective view of the frame in an unlocked position.

FIG. 10C is a perspective view of the frame in folded (and unlocked) position.

FIGS. 10A-10C represent an exemplary sequence of positions a frame may adopt during a dental procedure to retract a portion of a dental dam retained over a patient's mouth. The frame may allow the dental dam to be tucked out of the way during a dental procedure, thereby allowing access to the intraoral space. For example, enough of the dental dam may be retracted to allow a magnetically adjustable film holder into the intraoral space to allow the patient to have an X-Ray without disassembling the dental dam.

In some embodiments, the dental dam may exert a force on the first leg and second leg when the frame is unfolded. This tension may be released when the frame is folded.

FIG. 10D is an enlarged view of region 10D in FIG. 10A, showing a locking mechanism for the frame.

FIG. 10E is an enlarged view of region 10E in FIG. 10B, showing the locking mechanism.

FIG. 10F is an enlarged view of region 10F in FIG. 10C, showing the locking mechanism.

The locking mechanism comprises a rigid slider retained captive over the body of the frame, over and between the first and second legs. Sliding the rigid slider over the hinge (and the first and second legs at the same time) may obstruct movement of the first and second legs about the hinge. In some cases, with the dental dam installed, the dam may cover the locking mechanism.

FIG. 10G is an enlarged view of region 10G in FIG. 10B, showing a protrusion.

In various embodiments, the protrusion may be a metal dowel, a spike, barb, and/or extrusion. For example, metal dowels may be removable in some cases.

In various embodiments, the protrusions may be in unitary construction with one or more members or hinge of the frame. The protrusions may be pressed, glued, or otherwise secured to the frame. In various embodiments, the protrusions may be plastic, metal, or any other material. In various embodiments, the protrusions may or may not hold the dental dam to the frame in the folded position.

In some embodiments, the protrusions may be spikes. Spikes may be used to secure the dental dam to the frame, e.g. by puncturing.

In some embodiments, a separate tool may be used to puncture the dental dam to provides points of engagement with the protrusions.

In various embodiments, the protrusions may be sharp, blunt, or rounded. The protrusions may be cylindrical or triangular in shape, or designed in any geometry that aids in securing the dental dam.

The protrusions may generally be attachment features. For example, the attachment features may be hooks or other shapes to increase the grip of the dental dam in the unfolded and/or folded positions. In some embodiments, the dental dam may be secured by mechanical clips that slide over the frame to hold the dental dam in place using friction. Mechanical clips may be attached to the frame or provided as a separate part. In various embodiments, the mechanical clips may puncture the dental dam.

In various embodiments, attachment features may hold the dental dam in place by tension in the dental dam and/or by friction. If the attachment features are protrusions that are inserted into puncture holes in the dental dam, the puncture holes may exert force on the protrusions. The attachment features may have a barbed tip to retain the dental dam in place.

FIG. 11A is a perspective view of a frame for retaining a dental dam around a patient's mouth, in accordance with another embodiment.

FIG. 11B is a perspective view of the frame in a folded position.

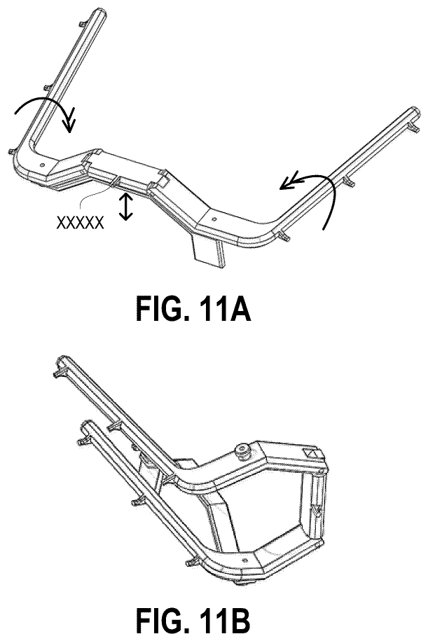

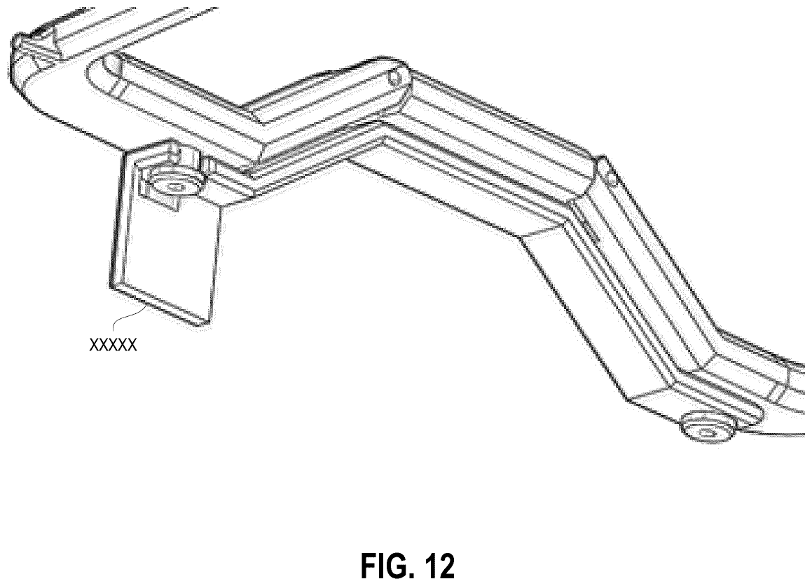

FIG. 12 is a perspective view of the frame, showing a locking mechanism of the frame.

The locking mechanism may include a substantially rigid plate conforming to the shape of the frame at the hinge and proximal thereto. The rigid plate may be rotatably coupled to the frame at one end via a pin joint attached to one of the legs of the frame. An opposite end of the rigid plate may have a slot to detachably engage with a complementary protrusion on the other leg of the frame. A tab may be provided for engaging or disengaging the slot with the frame.

Once a dental dam is engaged in tension with the frame, the dental dam may pull the frame towards it. The forces exerted by the dental dam may be exerted below the hinge of the frame, which may hinder the first and/or send legs from rotating away from the dental dam and prevent folding of the frame. The frame may be maintained in the unfolded position during treatment without a locking mechanism.

The frame may be transitioned from the unfolded state to the folded state by applying sufficient force to overcome the tension force generated by the dental dam. For example, by disengaging the dental dam from one or more protrusions of the raised portion to release the frame.

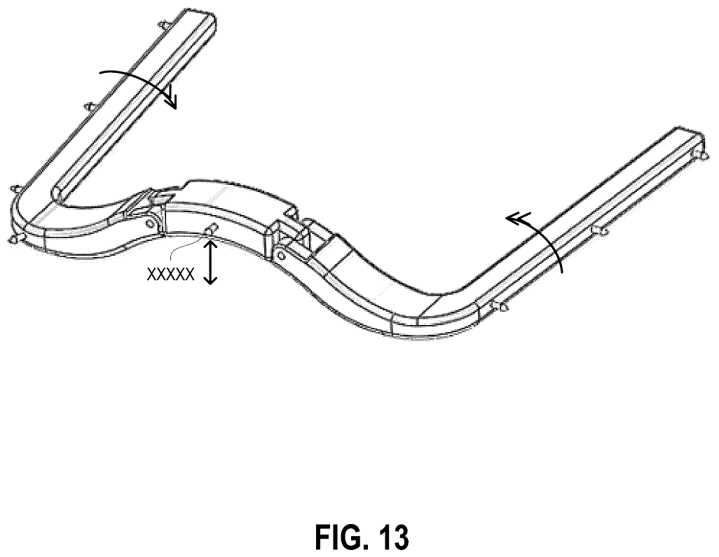

FIG. 13 is a perspective view of a frame for retaining a dental dam around a patient's mouth, in accordance with yet another embodiment.

In some aspects, the raised portion is an arcuate portion adapted to fit over the patient's chin.

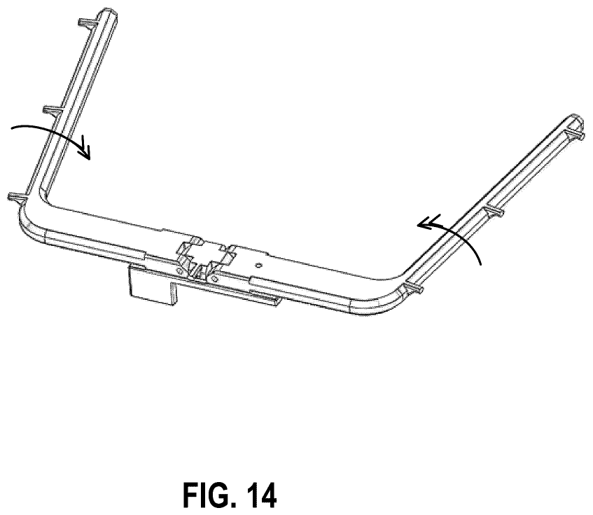

FIG. 14 is a perspective view of a frame for retaining a dental dam around a patient's mouth, in accordance with a further embodiment.

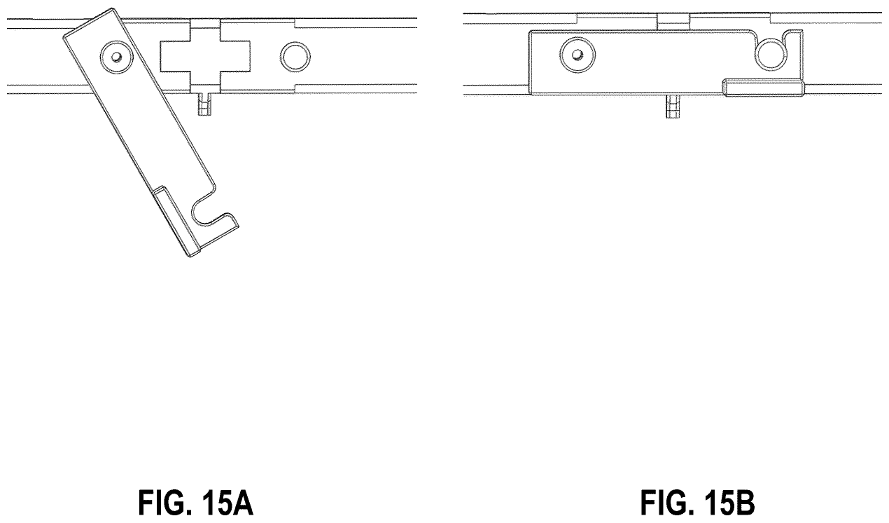

FIG. 15A is an enlarged bottom plan view of the frame, showing an embodiment of a locking mechanism in an unlocked position.

FIG. 15B is an enlarged bottom plan view of the frame, showing the locking mechanism in a locked position.

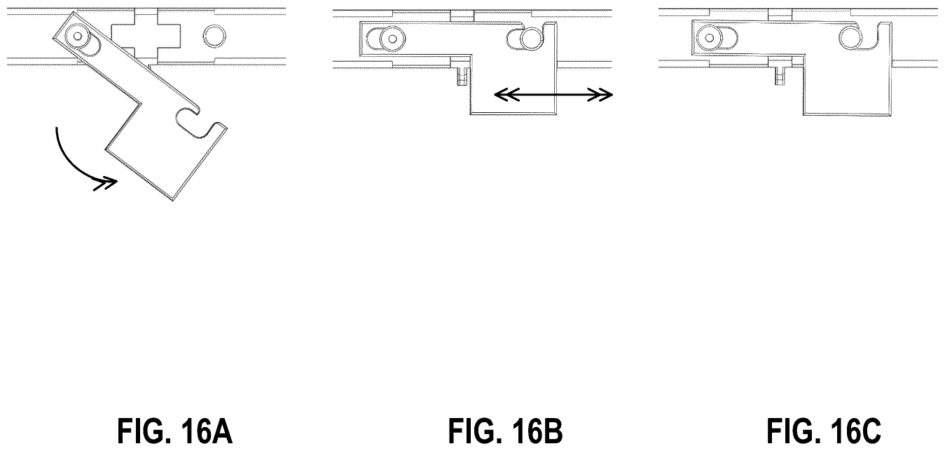

FIG. 16A is an enlarged bottom plan view of the frame, showing another embodiment of a locking mechanism in an unlocked position.

FIG. 16B is an enlarged bottom plan view of the frame, showing the locking mechanism in an intermediate position between locked and unlocked.

FIG. 16C is an enlarged bottom plan view of the frame, showing the locking mechanism in a locked position.

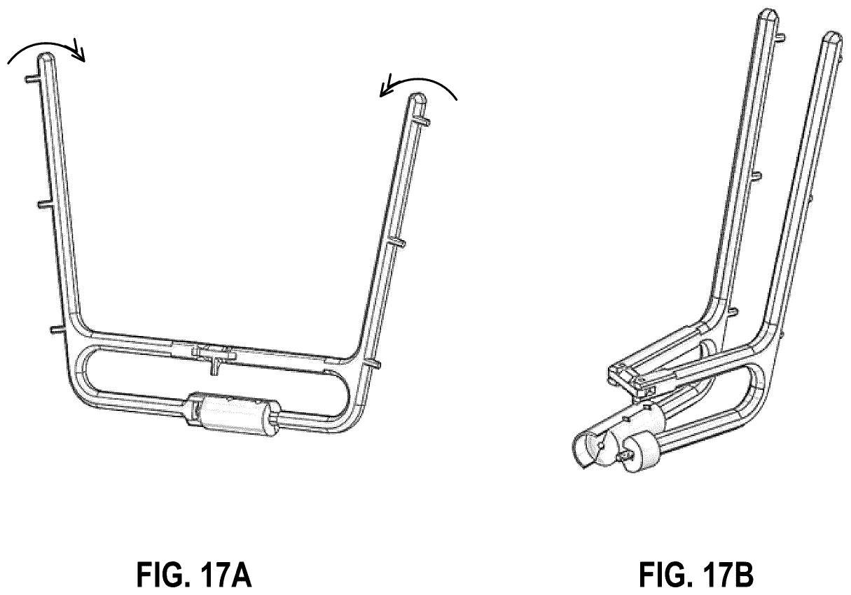

FIG. 17A is a perspective view of a frame for retaining a dental dam around a patient's mouth, in accordance with yet another embodiment.

FIG. 17B is a perspective view of the frame in a folded position.

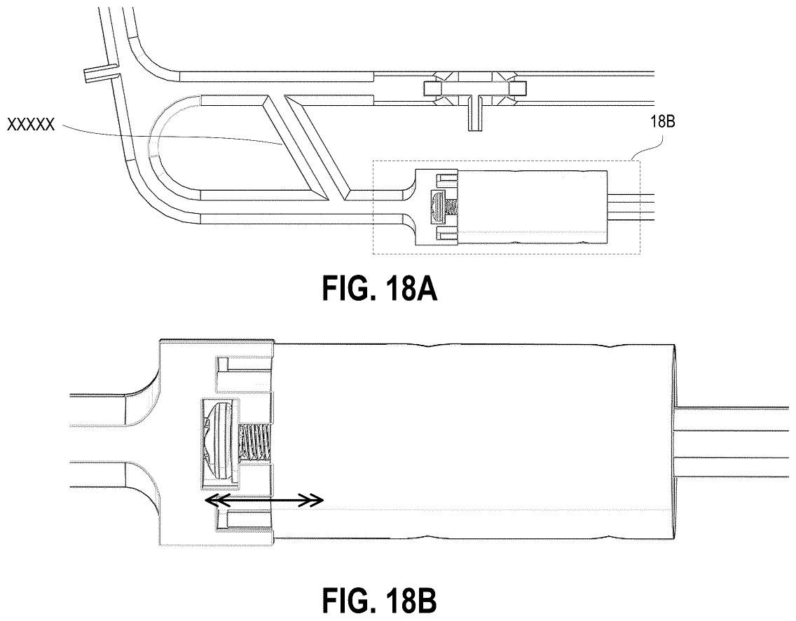

FIG. 18A is a front elevation view of a locking mechanism for the frame, in accordance with an embodiment.

FIG. 18B is a partial (enlarged) front elevation view of the frame with the locking mechanism installed.

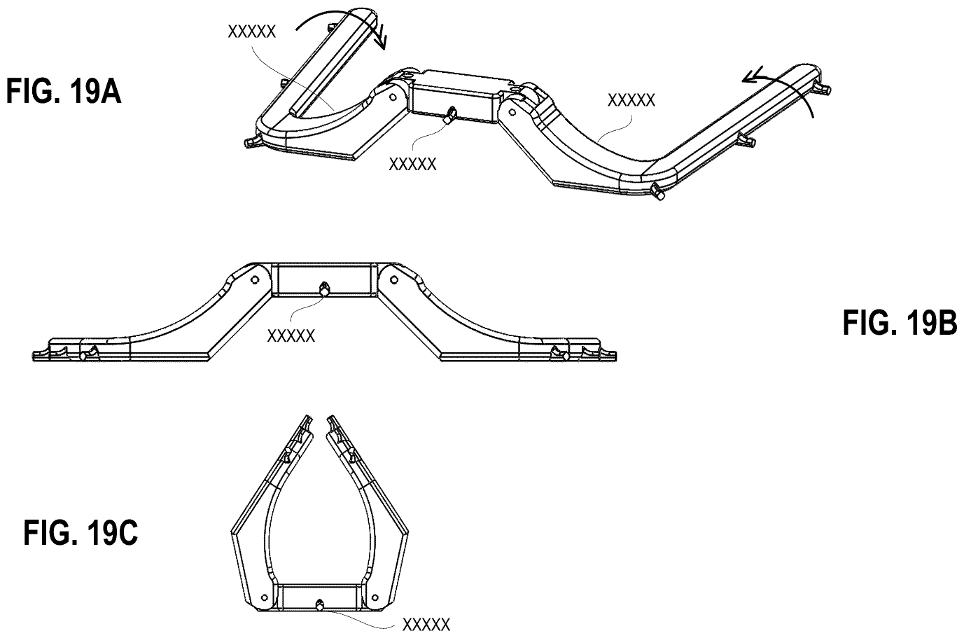

FIG. 19A is a perspective view of a frame for retaining a dental dam around a patient's mouth, in accordance with further embodiment.

FIG. 19B is a front elevation view of the frame, in an unfolded position.

FIG. 19C is a front elevation view of the frame, in a folded position.

Referring generally to FIGS. 10A-19C, the frame may include a first leg and second leg configured to engage with a dental dam, e.g. via protrusions or spikes, to extend the dental dam across an inter-leg space (space between the first and second legs).

In a first unfolded state of the frame during treatment, the first leg and second leg may be generally disposed on opposite sides of the patient's mouth (or around the patient's mouth) such that the patient's mouth may be generally placed in the inter-leg space. By engaging the dental dam on these opposite sides, the patient's mouth may be covered and the dental dam may be retained in tension.

The dental dam may comprise a first portion and a second portion. For example, the second portion may cover the area surrounding a region of interest (in the intraoral space) during treatment. The first and second portions may generally not coincide or may only partially coincide.

The second leg may be rotatably coupled to the first leg to retain around the patient's mouth the second portion.

In a second folded state of the frame during treatment, the second leg may retract the second portion away from the patient's mouth to give access to the intraoral space by rotating relative to the first leg. For example, such access may allow efficient dental radiography during a procedure, or allow vacuuming of fluids inside the mouth.

The first leg and second leg may be rotatably coupled to each other via a hinge, which may act as a bridge between the first leg and the second leg when the frame is unfolded. The hinge may include a protrusion to hold it in place (e.g. preventing folding) via the dental dam.

The first leg and second leg may be configured to couple to each other along a side of the frame distal from the patient's nose to prevent interaction of the frame with the nose.

The dental hinge may include two pivoting joints about which the frame may be rotated (double hinge mechanism). Each hinge of the double hinge mechanism may be folded in a range of angles between zero and approximately 180 degrees. In some embodiments, a hinge of the double hinge mechanism may be folded on either side of itself in a range between approximately negative 180 degrees and approximately positive 180 degrees. The pivoting joints may define colinear or parallel axes of rotation. One joint may couple the hinge to the first leg while another joint may couple the hinge to the second leg. Two hinge pins may allow full opening of the device (˜180-degrees), overcoming interference issues with a single hinge (interferes at ˜90 degrees). A double hinge may help a practitioner (e.g. a dentist) to continue working on a tooth during a procedure and only leave a small part of the frame unfolded, e.g. to allow the patient to breathe or to allow the use of suction.

In various embodiments, the hinge may be or may include a living hinge. In some embodiments, the first leg and the second leg may be directly rotatably coupled via a pivoting joint that is a hinge portion between the first leg and the second leg.

The first and second legs may be able to freely rotate up to 90° upwards during folding but may only rotate in such a manner in one direction. For example, rotation in an opposing direction may be hindered by interfering geometry of the hinge (e.g. see subsequent enlarged views in FIGS. 10D-10F). In some embodiments, the first and second legs may freely rotate both upwards and downwards, and/or more or less than 90°. In some embodiments, the hinge may allow rotation up to 360°.

In various embodiments, the hinge may be plastic or metal.

In some embodiments, the hinge may include a spring, e.g. a flexible strip, to hold the frame in a desired orientation or cause resiliency in the frame.

In some embodiments, to constrain the folding motion of the frame, mechanical limits (stops) may be provided at the desired extreme open and folded positions of the frame. For example, mechanical limits may be implemented to control functionality of the device, to improve usability, prevent failure, and increase safety. In some embodiments, an extreme open state may be chosen to maintain or make the frame stable when the dental dam is under tension. In some embodiments, an extreme folded state may prevent the protrusions and frame arms from touching, interacting, and/or damaging each other

The frame may include a raised portion for accommodating the patient's face underneath the raised portion. The raised portion may be raised relative to the first leg and the second leg, as these may rest on the patient's face (e.g. over the dental dam placed thereon). In various embodiments, the raised portion may be adapted to contours of the patient's face. For example, the raised portion may be at least as high above the first and second legs as a typical chin and/or nose height of a patient to facilitate placing the frame over the patient's chin and/or nose.

The first leg and the second leg may each have respective raised portions together defining the raised portion. The first leg may be coupled to the second leg via a bridge forming the raised portion. The bridge may comprise one or more pivoting joints coupling to the first and/or second legs. In some cases, for example, the bridge may be an extended hinge.

The first leg and second leg may be rotatable relative to each other via the bridge, i.e. they may not be directly coupled via a pivoting joint but rather through separate pivoting joints of the bridge.

A dental dam may be engaged with the frame such that it lies below the raised portion, rather than above it. The dental dam may be engaged with raised portion, e.g. by being pierced by one or more protrusions of the raised portion.

The embodiments of frames illustrated herein have a number of members, e.g. each leg may be considered a member. In some embodiments, additional members may be included. For example, in some embodiments, the one or more legs of the frame may each comprise a plurality of coupled members that together act as a leg. For example, a desired flexibility and strength may be achieved by using a variety of members and assemblies of members.

The frame (and legs thereof) may be constructed of materials of sufficient stiffness to withstand tension forces applied thereto by the dental dam, e.g. to prevent excessive deformation, while maintaining sufficient flexibility to facilitate installation of the dental dam using the frame.

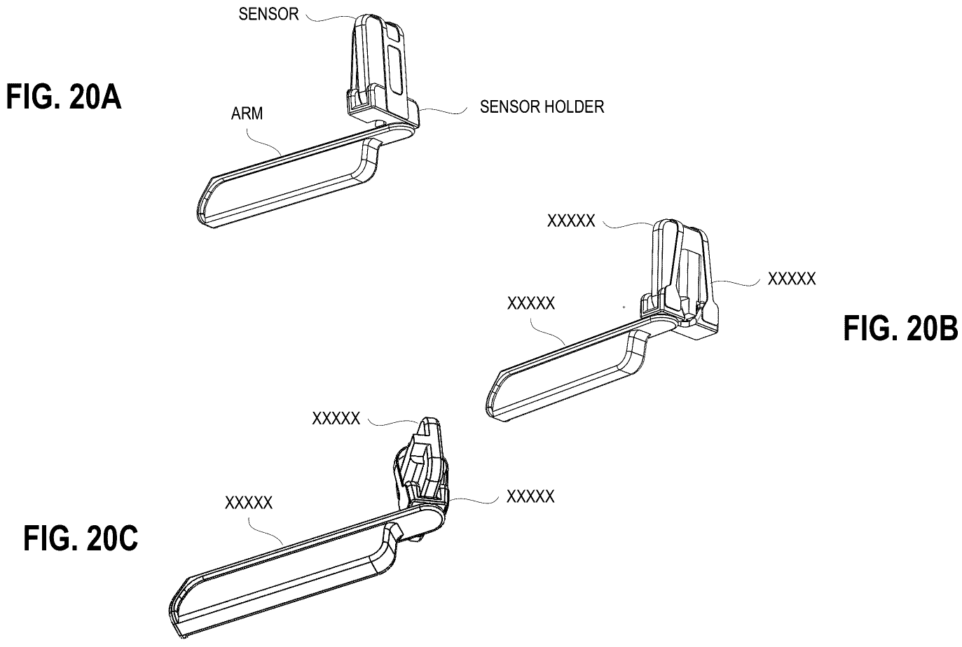

FIG. 20A is a perspective view of an apparatus for dental imaging, in accordance with an embodiment, and showing a sensor in a first position.

FIG. 20B is a perspective view of the apparatus, showing a sensor in a second position.

FIG. 20C is a perspective view of the apparatus, showing a sensor in a third position.

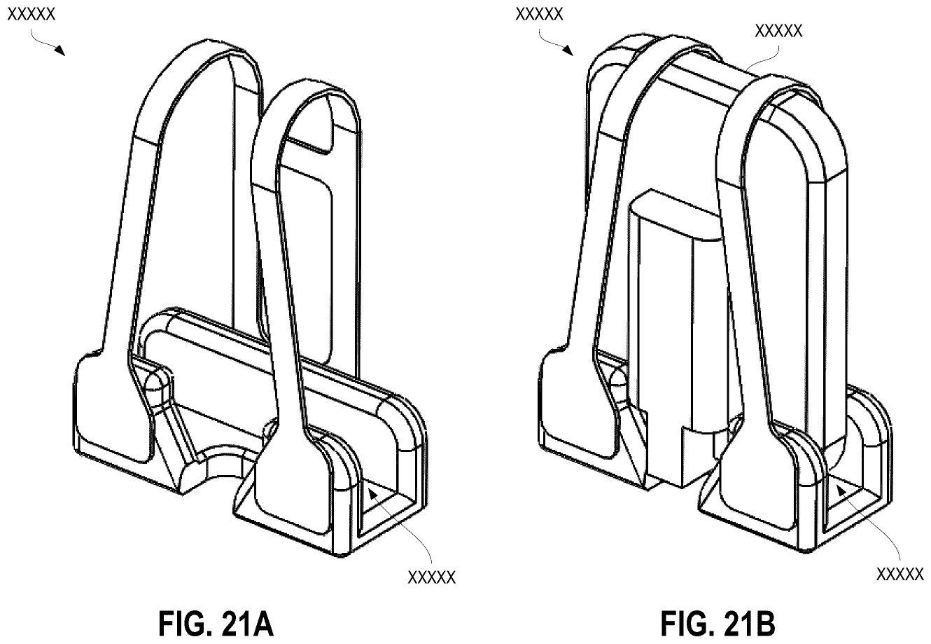

FIG. 21A is a perspective view of a sensor holder, in accordance with an embodiment.

FIG. 21B is a perspective view of the sensor with a sensor engaged therein.

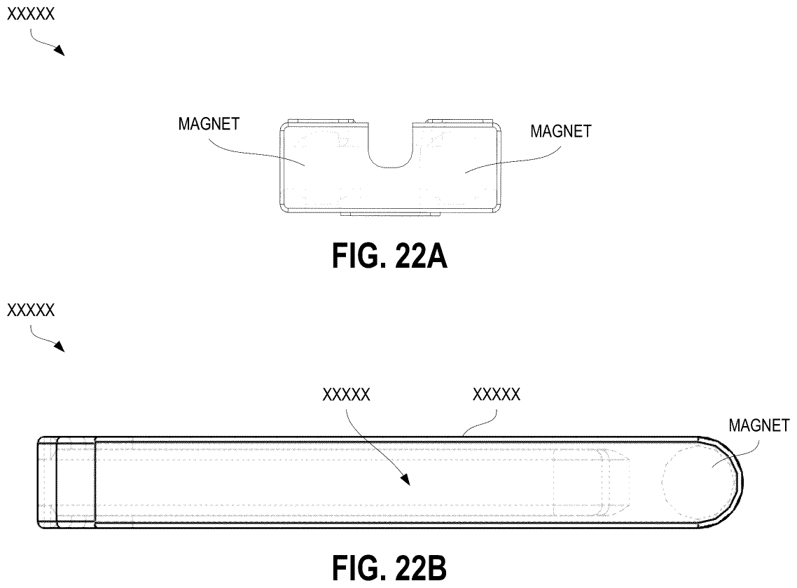

FIG. 22A is a plan view of the sensor holder, showing positions of embedded magnets.

FIG. 22B is a plan view of the arm of the apparatus, showing a position of an embedded magnet.

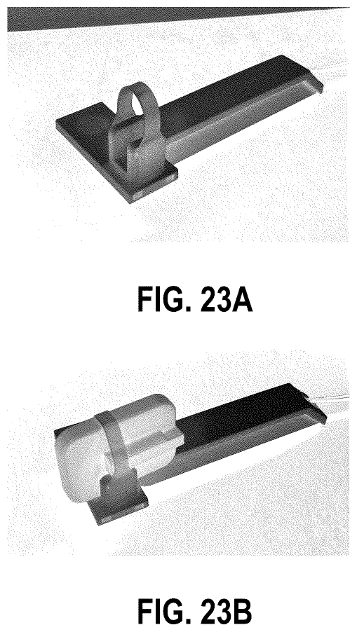

FIG. 23A is a perspective view of an apparatus for dental imaging, in accordance with an embodiment.

FIG. 23B is a perspective view of the apparatus equipped with a sensor.

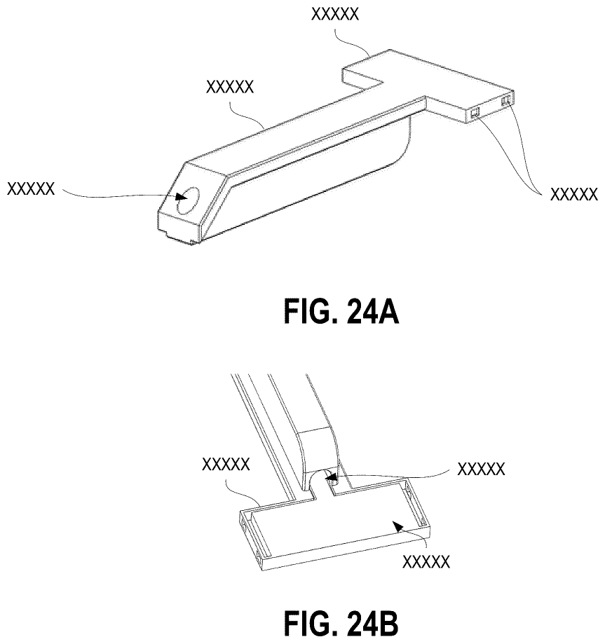

FIG. 24A is a rear perspective view of an arm of the apparatus.

FIG. 24B is a front perspective view of the arm.

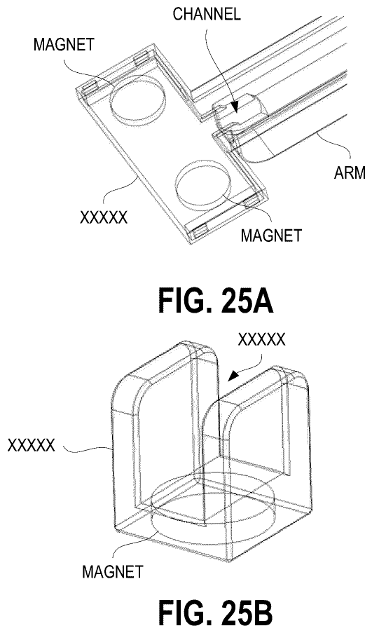

FIG. 25A is a perspective view of the arm showing locations of embedded magnets.

FIG. 25B is a perspective view of the sensor holder showing a location of an embedded magnet.

Referring to FIGS. 20A-25B generally, an apparatus for dental imaging may be provided, comprising: at least one magnet; and an arm coupled to a sensor via the at least one magnet, the arm configured to be held when engaged with the sensor to hold the sensor in an intraoral position.

In some embodiments, the arm may be configured to be bit when engaged with the sensor to hold the sensor in an intraoral position. In some embodiments, the arm may be held by a user (e.g. patient, doctor, or attendant).

In various embodiments, the arm may be made out of a rigid, soft, or mixed material. In some embodiments, the arm may have depth markers to aid in positioning.

In various embodiments, the arm or handle may have a straight or T shape.

The straight handle consist of a handle with a single attachment extension. The attachment extension may be inline with the handle or offset. The attachment extension is located at the tip of the straight handle. The straight handle is generally intended to be used to secure the sensor holder in the front of the mouth. Sensor holder can be located at the tip of the handle. This allows the patient to bite down on the handle and have the film be right behind the upper and lower front teeth.

The t shape handle may have a central gripping section and two or more attachment extensions protruding from the sides that create a ‘t’ shape. The sensor holder can be located on either of the attachment extensions. The t shape handle may be used primarily for back teeth.

The sensor holder may be held to the handle by an attachment mechanism. The attachment mechanism may include one or more magnets, gears, twist-lock couplings, tapered fittings, mechanical clips, adhesives or other sticky surfaces, or any other mechanical interfaces relying on magnetism, friction, interlocking features, or chemical attraction. Mechanical features may include radial grooves, linear grooves, bumps, pins, holes, tabs, slots. The attachment mechanism may hold the sensor holder or other accessories securely to the handle while allowing the sensor holder to rotate freely relative to the handle to allow adjustment of the sensor holder position/orientation.

The attachment mechanism may secure the sensor holder in fixed rotational angle of any degree or combination of angles, such as 90-degree or 45-degree increments, while allowing adjustment from one position to another. Magnets may be integrated or embedded into the handle to prevent the magnets from falling out of the handle. Magnets may be housed in a portion of the handle called a magnet extension

Magnet extensions may include one or more magnets. Multiple magnets may be oriented in different polarities to attract from different directions, such as up, down, left, right, in, out. Magnets may be placed as close to the surface of components as possible to maximize the magnetic forces. Magnets may be used to secure the sensor holder, alignment ring, or other accessories to the handle.

The arm may interact with an external alignment ring to help align imaging equipment with the sensor (e.g. X-ray tube) secured in the sensor holder inside the patient's mouth. The alignment ring may contain magnets. The alignment ring may secure to the handle using magnets. The alignment ring may be placed on the outside of the patient's cheek and the magnets thereof are attracted to magnets on the handle to hold the alignment ring securely to the cheek by magnetism alone. The alignment ring may include lights.

LEDs or other illuminating device or method (lights) may be incorporated into the handle, sensor holder, or alignment ring. Lights may emit wavelengths in the visible, UV, IR spectrums, including any combination thereof. Lights may help the operator align imaging equipment (e.g. X-ray tube) to the sensor in the sensor holder by illuminating the inside of the patient's cheek in a manner that is visible from outside. Lights may help illuminate the inside of the patient's mouth. Lights may be mounted on the handle, including in the magnet extensions. On a T shape handle, the lights may be mounted on the outside of the magnet extensions such that light is directed toward the cheek. The light emitted may be strong enough to pass through the cheek of the patient. This light can then be used to align the X-ray machine to prevents unnecessary radiation exposure due to misalignment and multiple X-ray exposures. Lights may be powered by a battery power supply or external power adaptor.

A sensor holder may be designed to hold the digital imaging sensor (e.g. digital film X-ray used by modern X-ray machines). The sensor holder may be rigid or somewhat soft (such as silicone). One or more attachment mechanisms may be incorporated into the sensor holder to facilitate positioning of the sensor inside the mouth (front, left, right, back of mouth). The sensor may be held in the sensor holder by a rigid clamp mechanism, by compliant sensor bands, or a combination thereof. The sensor holder may utilize one or more sensor bands or clamp mechanism. Sensor bands secure the sensor in the sensor holder by wrapping around the sensor. Sensor bands should allow inserting and removing the sensor from the sensor holder without exerting excess force. Sensor bands may be made of a flexible, elastic material such as silicone or rubber that can be stretched over the sensor to hold the sensor to the sensor holder. The sensor bands may be made of a hook and loop material or similar configuration to allow repeated attachment and detachment of the sensor bands from the sensor. Sensor bands may be permanently mounted to the sensor holder or provided as a reusable accessory that attaches using a mechanical means. Sensor bands may be secured to the sensor holder by adhesive, mechanical fastener, or the sensor straps may be an integral part of the sensor holder. The sensor holder may hold the sensor in a vertical orientation, a horizontal orientation, or any other orientation required to adequately position inside the patients mouth and allow X-ray images to be captured. The sensor holder may include mechanical features to align the sensor body, such as groove/s to hold the cable connected to the sensor body, a channel to hold the sensor body, or markings to ensure proper positioning of the sensor body in the sensor holder.

An exemplary method of taking an X-ray of the back teeth includes using a finger, lifting the silicone of the back teeth film holder slightly, sliding the sensor into the holder until it can no longer move anymore in, release silicone to secure the sensor to the film holder, determining what side the X-ray is being taken on, placing the film holder on that side of the T-shaped Handle, placing the handle in the mouth of the patient and locating the area that an X-ray will be taken of, using the LED's, aligning the X-ray machine with the light, and finally, taking the X-ray.

An exemplary method of taking an X-ray of the front teeth includes passing the sensor through the middle of the front teeth film holder, ensuring wire is aligned with the central channel, lowering the digital film until it is sitting in the slot of the film holder, placing each silicone strap over the sensor and securing it in place, determining where the X-ray will be taken and place the film holder on the straight handle on the appropriate side, carefully placing the digital film behind the appropriate area, aligning the X-ray machine with the digital film, and, finally, taking the X-ray.

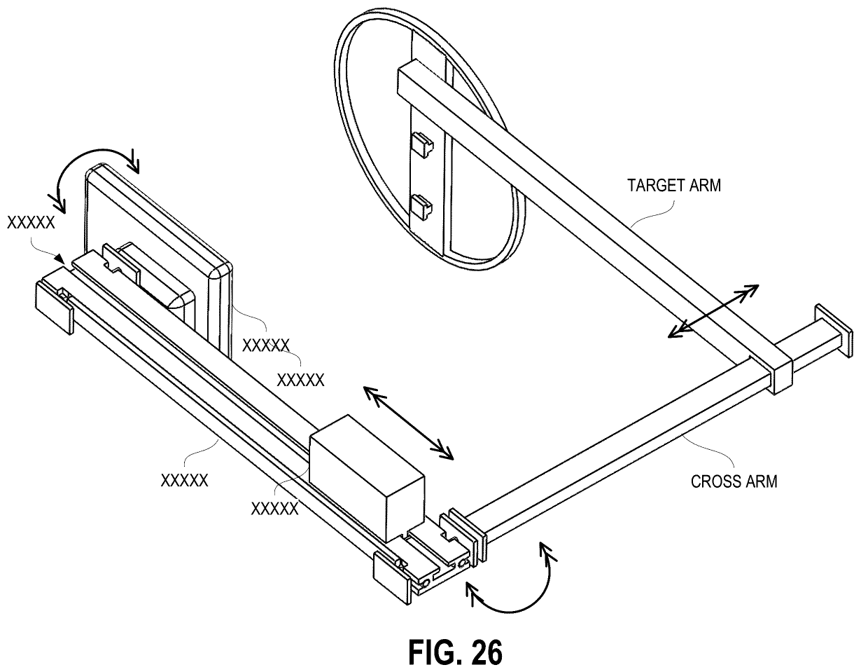

FIG. 26 is a perspective view of an apparatus for dental imaging, in accordance with an embodiment.

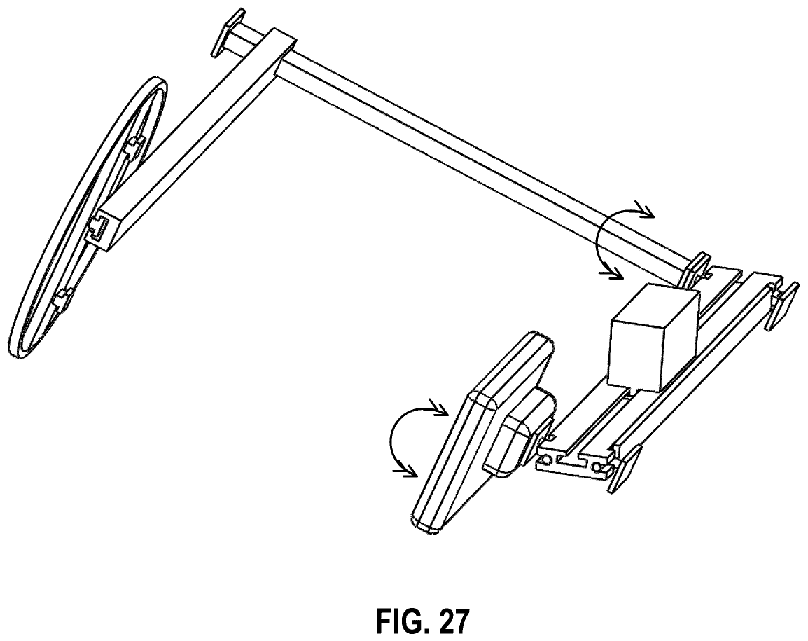

FIG. 27 is another perspective view of the apparatus.

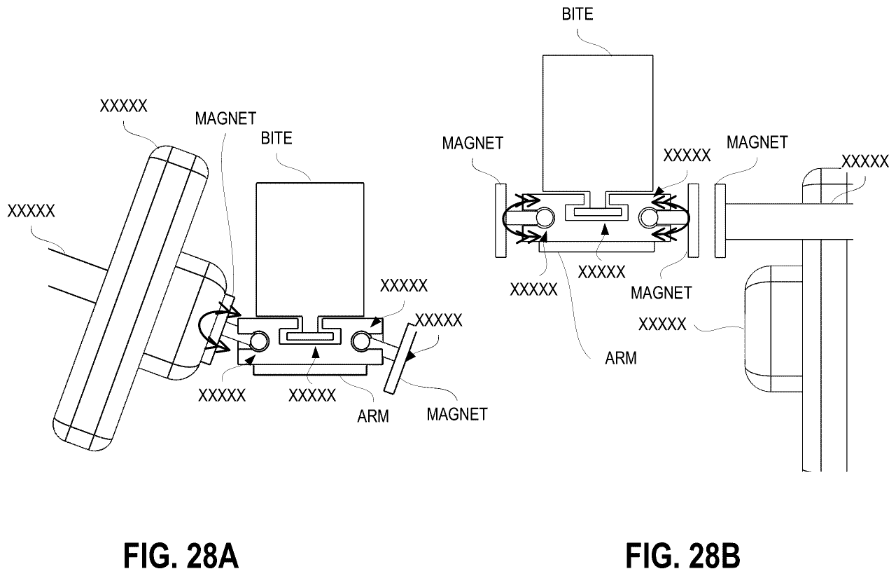

FIG. 28A is a front elevation view of the apparatus, showing the sensor magnetically engaged with a bite arm.

FIG. 28B is a rear elevation view of the apparatus, showing the bite arm magnetically engaged with the cross-arm.

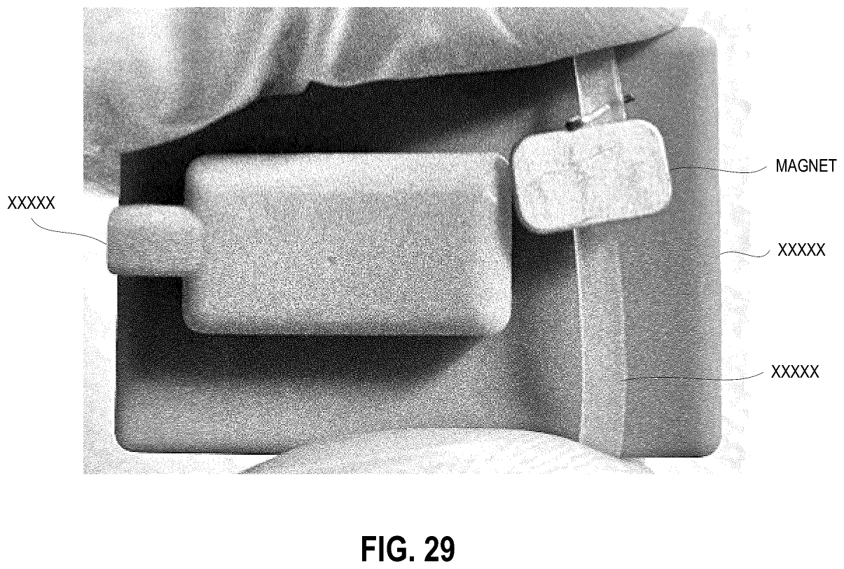

FIG. 29 is a back view of a sensor engaged with a magnet strap, in accordance with an embodiment.

Referring to FIGS. 26-29 generally, an apparatus for dental imaging may be provided, comprising: an arm coupled to a sensor; and a bite coupled to the arm to hold the sensor in an intraoral position by a patient, the bite movably engaged with the arm to define a biting position adapted to the patient.

In some embodiments, dental imaging may refer to dental radiography, e.g. X-ray imaging. In some embodiments, dental imaging may include optical imaging.

In some embodiments, at least one magnet may include two or more magnets, e.g. spaced apart magnets for providing two or more engagement (coupling) positions. In some embodiments, at least one embodiment may include an assembly of magnets configured to cooperate together to facilitate engagement (coupling). In various embodiments, magnets may include rare-earth magnets, such as neodymium (NdFeB) magnets.

In various embodiments, sensors may include X-ray sensors, or charged-couple device (CCD) sensors. The sensor may be movably engaged with the arm via the at least one magnet.

The arm may allow the sensor to be held in an intraoral position for imaging. When engaged with the sensor, the arm may be configured to be held down, e.g. using hands or by biting down thereon. For example, the arm may be adapted to a patient's mouth or the average mouth of a patient (or patient type). In some embodiments, the length of the arm may be sufficiently large to be placed in the mouth and held down. In some embodiments, the shape of the arm may be adapted to the mouth. In various embodiments, the arm may be bit down on directly or may be bit down via another component. For example, a bite engaged with the arm may be disposed between a tooth and the arm during biting.

Two sets of magnets may be provided on the bite arm that are each connected by a ‘hinge’. The two hinges may be mechanically connected such that they are always parallel. This may allow the sensor to be attached to the bite arm at an angle (angle relative between sensor and bite block), but the sensor and alignment ring are always parallel.

In various embodiments, the apparatus may be a universal system to facilitate placement of a digital sensor in all areas of the patient's mouth (top, bottom, front, back). The system may reduce the number of pieces a doctor needs to take radiographs. It may also allow for patients with disability to hold the sensor in place by biting down on a movable bite block instead of holding it with their hands. The movable bite block may also allow taking radiographs on pediatric population without asking their parents to hold a sensor down.

In some embodiments, the sensor holder consists of a flexible (silicone or any compatible/comparable material) strap with a magnet or any other form of bounding attached. The flexible strap may slide securely over various sensor types and may allow them to be attached to the bite arm using an embedded or integrated magnet.

In various embodiments, attachment mechanism including screws, magnets, pins and holes, clips, rigid or flexible materials may be used to hold the sensor in position on the bite arm.

In various embodiments, the sensor may be selectively positioned in at least three different attachment locations to the bite arm for maxillary or mandibular periapical radiographs, or bite wing radiographs (high, middle, low).

The arm movably engaged with the bite may be referred to as the bite arm. The arm may have a groove (dovetail or similar feature) is located lengthwise on the top for insertion of the bite block (or bite) onto the arm. For example, the groove may have mechanical stops to vary positioning of the block thereon. Magnets on both the left and right sides of the front and back of the arm may allow the sensor holder and cross arm to be attached to any of four positions, depending on the required positioning in the patient's mouth. Magnets may be located on both front and back ends on the bottom side to attach the sensor holder for front teeth.

The bite or bite block may be a block of plastic or other soft material, such as silicone, with a groove or similar feature on one side complementary and/or engagable with the groove on the bite arm. The bite block may be held to the bite arm while being allowed to slide front to back. A doctor may place the bite arm with sensor in the patient's mouth, then slide the bite block into a position that allows the patient to comfortably bite down on the bite arm and bite block to securely hold the system in place during an imaging procedure.

The cross arm may be a long rigid member with magnets on both ends. The cross section of the cross arm may be square, rectangular or other shapes that may allow a target (via a target arm) to be attached without rotating. Once the bite arm with sensor is secured in a patient's mouth, the cross arm may be attached to one of the magnets on the exposed end of the bite arm, outside the patient's mouth. The cross arm may be held perpendicular to, and in the same plane as, the bite arm. The magnets on both ends of the bite arm may be connected through a connecting bar passing through the bite arm allowing them to rotate together (co-rotation). The connecting bar allows to orient the sensor with the cross arm, target arm, and target when the sensor is placed next to the target tooth and patient bites down on the bite block.

The target arm may be a long member with a notch, grooves, or similar feature in one end to mount the target. On the opposite end of the target mount (opposite to the end having the target) may be a feature allowing for movable engagement with the cross arm. The movable engagement may be linear movable engagement, e.g. rotation may not be possible or hindered. For example, the feature may be square aperture (or similar structure) to slide over the cross arm. This feature may hold the target arm securely to the cross arm while allowing it to slide left and right to move closer or farther from the sensor. This may allow the target to be positioned close to the patient's cheek regardless of sensor location. The target arm may not rotate relative to the cross arm.

The target may be used to align the imaging equipment (X-ray tube) with the sensor when the sensor is not visible inside the patient's mouth. Three features on the target may allow three different attachment locations to the target arm (high, middle, low). The three different features may allow orientation of the target with the sensor for maxillary or mandibular periapical radiographs, or bitewing radiographs.

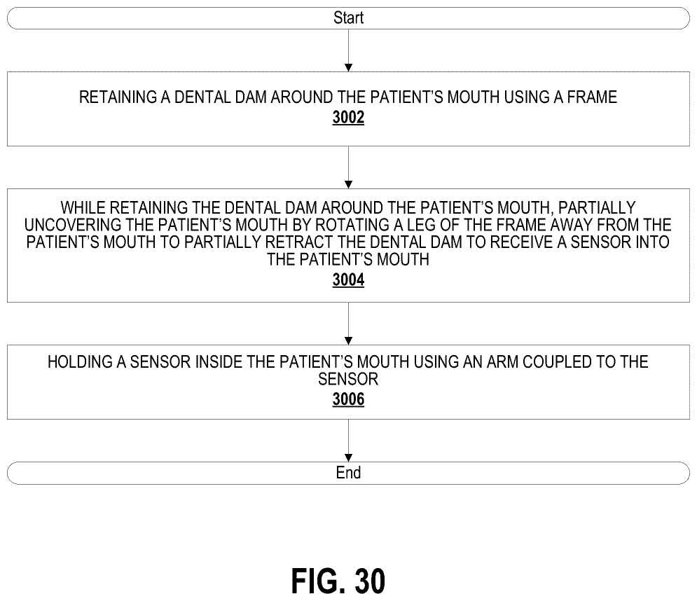

FIG. 30 is a flow chart of an exemplary method of sensor placement for intraoral dental imaging during dental treatment of a patient.

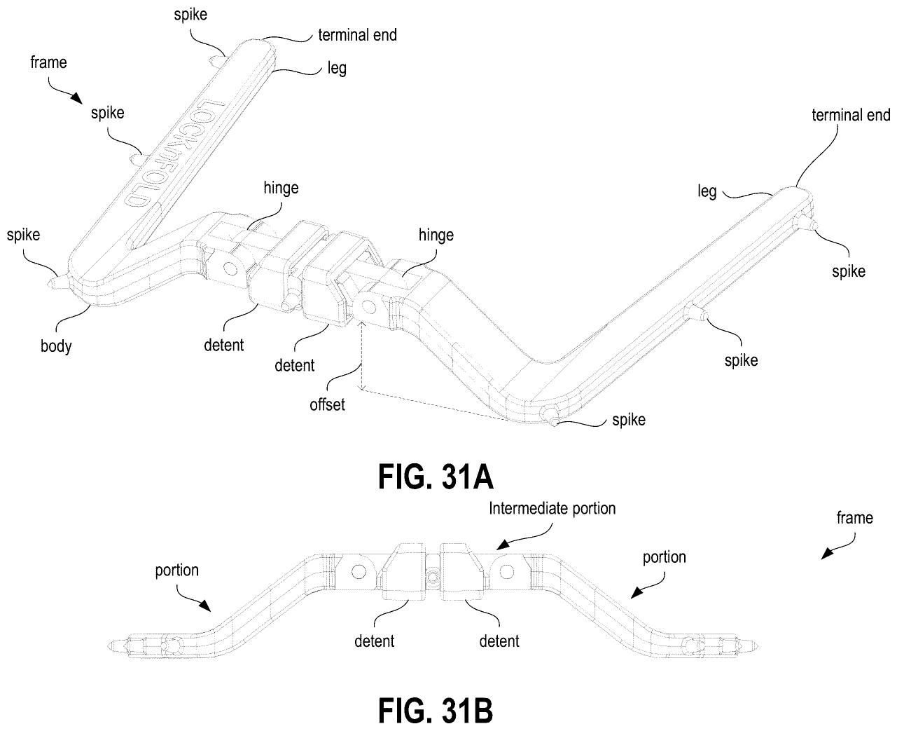

FIG. 31A is a perspective view of frame for a dental dam in an open configuration, in accordance with an embodiment;

FIG. 31B is a front elevation view of the frame as shown in FIG. 31A;

The frame may be suitable for use with a dental dam during a dental procedure on a patient. In particular, the frame may allow intraprocedural access to an oral cavity of the patient. As referred to herein, dental procedure may refer to dental surgery or other procedures performed by a dentist, hygienist, or other practitioner operating in the mouth of a patient.

The frame has a body that defines two portions situated on opposite sides of the body. For example, in some embodiments, the two portions may be on opposite sides, or may be defined by opposite sides, of the frame about a line of symmetry thereof. The two portions are configured to engage with the dental dam, such as by frictional engagement with spikes or other protrusions on the portions. A plurality of spikes may extend outwardly from the two portions to pierce and frictionally engage with the dental dam. In some embodiments, other means of engagement methods may be provided, e.g. clasps for retaining a portion of the dental dam.

The body is conformationally adaptable between an open configuration and a retracted configuration, such as by the body's shape being adapted to conform to either one of the open or retracted configuration. In the open configuration, the two portions (first and second portions) are splayed away from each other to spread out the dental dam. In the retracted configuration, the two portions are drawn towards each other to fold the dental dam. In moving from the open configuration to the retracted configuration, one or more parts of the dental dam may be drawn away from the patient's mouth to allow access to the oral cavity. In various embodiments, the body may be conformationally adaptable from the open configuration to one or more retracted configurations. The open configuration may refer to a configuration where the frame and dental dam are suitable to block access to the oral cavity and provide a suitable barrier for performing a dental procedure. In some embodiments, movement between the open and retracted configurations allows rapid and convenient access to the oral cavity. For example, the dental dam may not need to be fully removed and may be redeployed after temporary retraction by the frame, thereby saving dental procedure or surgery time. It is understood that the dental dam may be appropriate for dental surgery, e.g. it may be provided with openings (surgical cut-outs) for facilitating operation on one or more teeth of the patient.

As shown in FIGS. 31A-31B, the body is elongated between the opposite sides between opposing terminal ends, i.e. from a first terminal end to a second terminal end. The second terminal end is spaced apart from the first terminal end to form a gap at an end of the frame. This gap allows flexible fitting of the frame on patients. The first and second portions of the body are respective first and second pieces. The first and second pieces define the respective first and second terminal ends and are attached to respective first and second parts of the dental dam. For example, half of the dental dam may be attached to one of the two pieces while the other half of the dental dam may be attached to the other one of the two pieces. The first and second portions are attached to each other via an intermediate portion disposed between the first and second portions. The first and second portions are independently rotatable relative to the intermediate portion to permit the first and second parts of the dental dam to be selectively retracted towards each other. The intermediate portion is an intermediate piece with the first and second pieces being hinged at opposed ends of the intermediate portion to allow independent rotation of each of the first and second pieces about the intermediate piece. This double-hinged arrangement allows for a smaller part of the frame to be rotated or retracted at a time, which also reduces risks associated with removing a surgical barrier during a dental procedure. Such an arrangement also allows simultaneous retraction of either or both sides of the frame at the same time to retract the attendant parts of the dental dam. The frame includes a first detent selectively engageable with a first hinge hinging the first piece to the intermediate piece to prevent rotation of the first and intermediate pieces about the first hinge, and a second detent selectively engageable with a second hinge hinging the second piece to the intermediate piece to prevent rotation of the second and intermediate pieces about the second hinge. The first and second detents may be sleeves that are slidably engageable with, respectively, the first and second pieces to at least partially girdle or encase (or cover) the respective first and second hinges to obstruct rotation of the first and second pieces about the hinge, i.e. by providing an abutting surface that acts as a stop. It is understood that detents may be provided that are not sleeves, e.g. a detent or stop for a pivoting joint (such as one disposed inside the hinge). Furthermore, at least partially girdling may include girdling or encasement caused by a C-shaped sleeve.

In some embodiments, the frame may not include a specific intermediate piece. For example, the body may include a hinge coupling the first piece to the second piece to allow rotation of the first and second pieces relative to each other to allow retraction of the first and second parts of the dental dam over each other. In some of these embodiments, the body includes a detent selectively engageable with the hinge to prevent rotation of the first and second pieces relative to each other. In some of these embodiments, the detent is slidably engageable with the first piece to at least partially girdle the hinge to obstruct rotation of the first and second pieces about the hinge. The detent encases or covers the hinge so that the first and second piece cannot rotate about the pivot axis without encountering the detent, i.e. the detent provides an abutting surface that acts as a stop.

As shown in FIGS. 31A-31B, the first and second portions of the body extend in a common plane and connect to each other in a plane that is offset from the common plane to facilitate fitting of the frame (see the offset distance indicated in FIG. 31A). This facilitates fitting of the frame on a patient's face around the mouth, e.g. over a chin or nose of a patient.

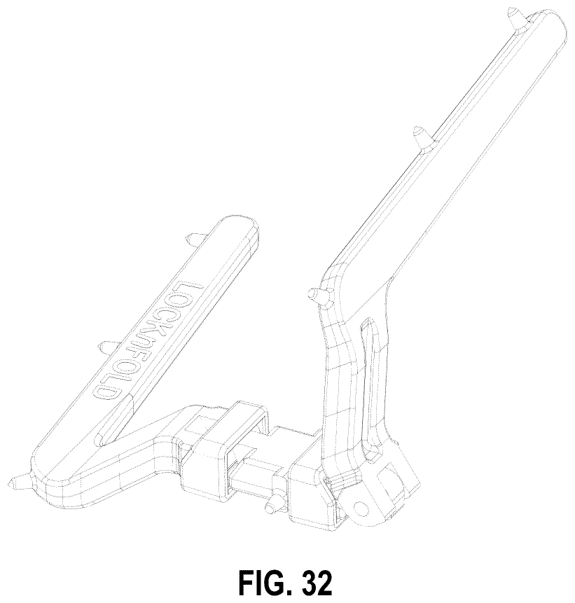

FIG. 32 is a perspective view of the frame of FIGS. 31A-31B in a first retracted configuration, in accordance with an embodiment.

In such a first retracted configuration, one side or part of the dental dam can be retracted

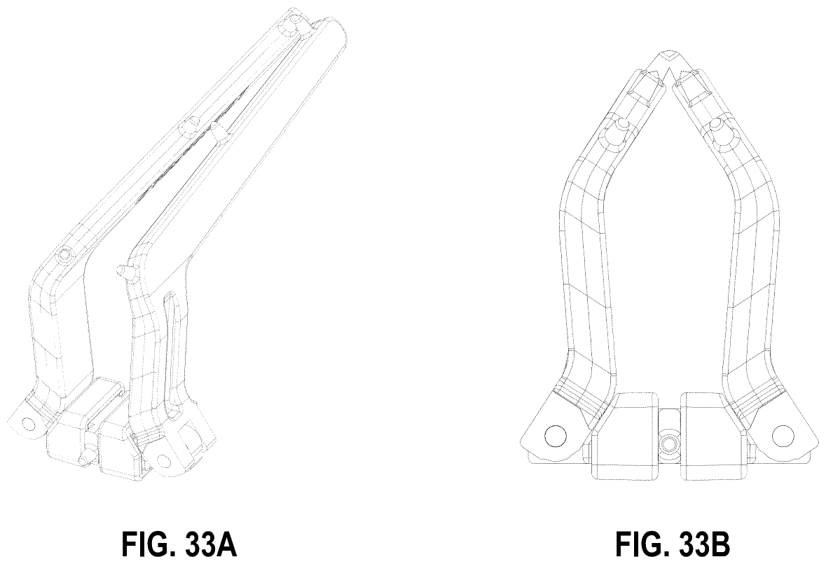

FIG. 33A is a perspective view of the frame of FIGS. 31A-31B in a second retracted configuration, in accordance with an embodiment.

FIG. 33B is a front elevation view of the frame as shown in FIG. 33A.

In such a second retracted configuration, both sides or both parts of the dental dam.

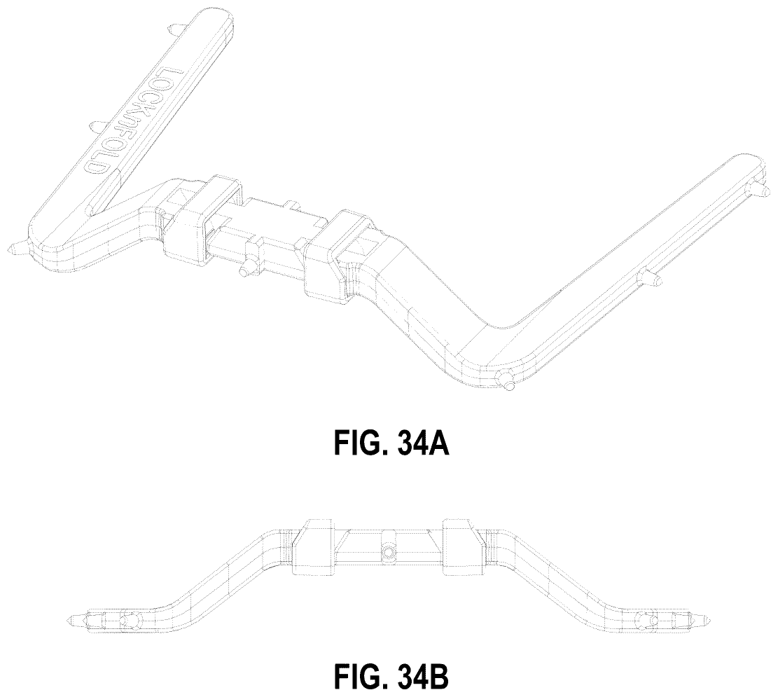

FIG. 34A is a perspective view of the frame of FIGS. 31A-31B in an open configuration. The detents are engaged to keep the frame in the open configuration.

FIG. 34B is a front elevation view of the frame as shown in FIG. 34A;

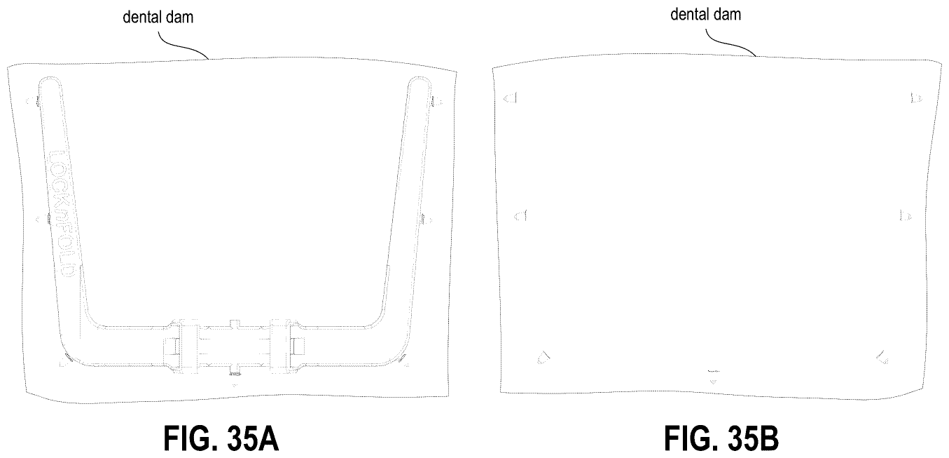

FIG. 35A is a top plan view of the frame of FIGS. 31A-31B engaged with a dental dam, in accordance with an embodiment; The spikes, or portions thereof underneath the dental dam, are shown in phantom.

FIG. 35B is a bottom plan view of the frame as shown in FIG. 35A; In some embodiments, the frame may be provided as part of a kit for use in a dental procedure to facilitate intraprocedural access to a patient's oral cavity. Such a frame may be mounted over the oral cavity such that the open configuration is suitable to hinder access to the oral cavity and the retracted configuration is suitable to allow access to the oral cavity. One or more tools may be provided as part of the kit to enable additional procedures while the dental dam is retracted. In some embodiments, as described below, a device may be provided for positioning a component intraorally, e.g. for positioning an sensor intraorally such that it is targetable from an extraoral position for dental imaging purposes.

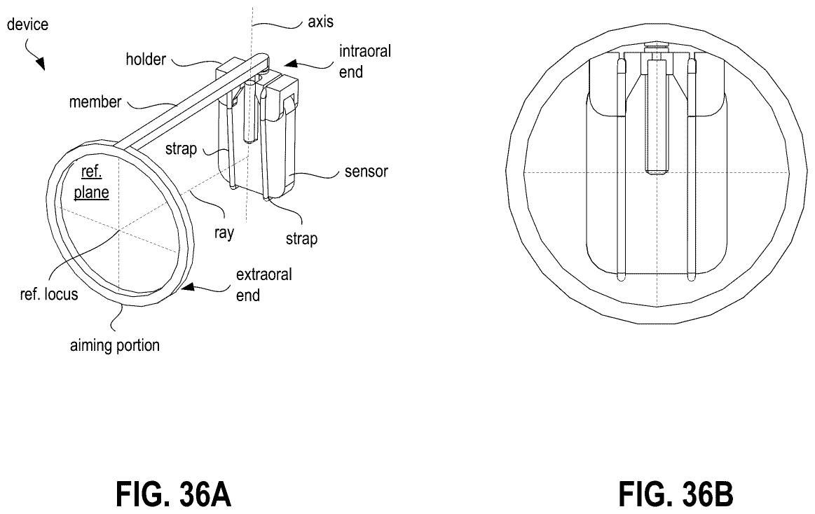

FIG. 36A is a perspective of a device for positioning a sensor inside an oral cavity of a patient, in accordance with an embodiment.

FIG. 36B is a front elevation view of the device as shown in FIG. 36A.

The device may form part of a kit including the frame.

The device includes a member suitable for biting by teeth. The member is elongated between an intraoral end and an extraoral end. The member may generally be rigid. In some embodiments, the member is substantially linear. In some embodiments, the member includes multiple linear portions joined to each other at angles to each other. In some embodiments, the intraoral end may refer to an end of the member closer to an intraoral end of the device and the extraoral end may refer to an end of the member closer to an extraoral end of the device.

The device includes an intraoral fitting at the intraoral end. In some embodiments, the intraoral fitting includes a sensor holder and a sensor for dental imaging removably attached to the sensor holder. For example, the sensor may be an X-ray imaging sensor. It is understood that other types of intraoral fittings may be used in place of a dental sensor and holder therefor. In general, any type of fitting that is benefited by extraoral locating/referencing of the fitting may be fruitfully used. In some embodiments, the intraoral fitting may refer to fitting that is at least partially disposed intraorally and, in particular, the intraoral fitting has one end suitable for being disposed in the oral cavity.

In some embodiments, the sensor holder may be rotatable about one axis, or more axes in some cases, at the intraoral end. This may allow precise positioning and orientating of the sensor holder in the oral cavity. The sensor holder may include one or more straps, e.g. flexible or resilient straps, for retaining the sensor in the sensor holder.

The device includes an aiming portion at the extraoral end that is positioned complementarily to the intraoral fitting about the member to facilitate extraoral targeting of the intraoral fitting. The aiming portion is shaped to extend at least partially laterally from the member to define a reference plane and a reference locus in the reference plane such that a ray (a notional line) defined by the reference plane and the reference locus traverses (i.e. notionally intersects) the intraoral fitting. The reference locus may generally refer to a position of a distinguished point in the reference plane. A ray may be defined as emanating from such a reference locus along an orientation defined by the reference plane (normal and/or parallel to the reference plane). For example, the aiming portion may be ring-shaped, as shown, where the plane of the ring defines the reference plane and the unique center of the ring is the distinguished point defining the reference locus. In some embodiments, the aiming portion may be cross-hair-shaped, where the plane of the two lines of the cross-hair shape defines the reference plane and the intersection of the two lines defines the reference locus. It is understood that other shapes may at least partially serve similar purposes.

The device, as a whole or the portions thereof connecting the intraoral end to the extraoral end, may be substantially rigid to allow geometric referencing or locating of components at the intraoral end via the extraoral end.

In some embodiments, the member may be C-shaped or U-shaped with the intraoral fitting and the aiming portion at opposing ends such a member.

In some embodiments, the aiming portion may be in unitary construction with the member.

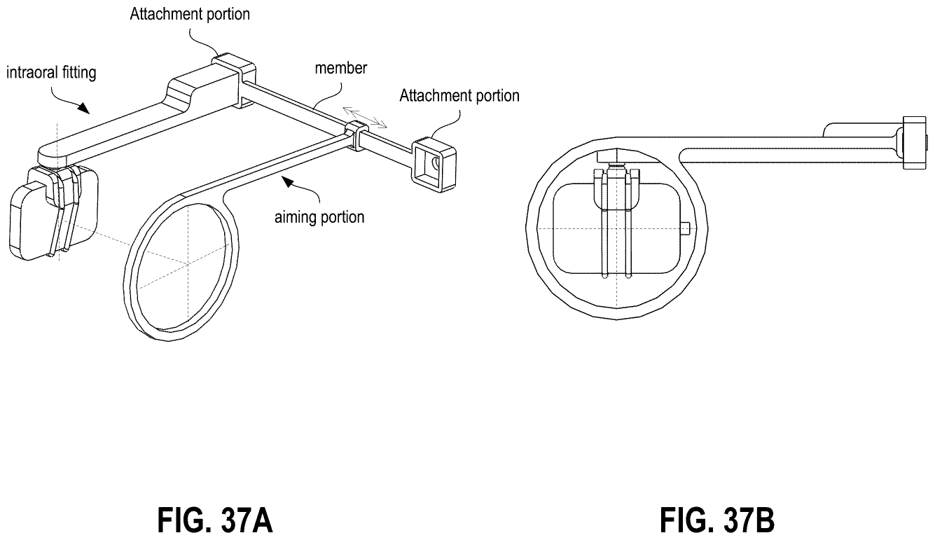

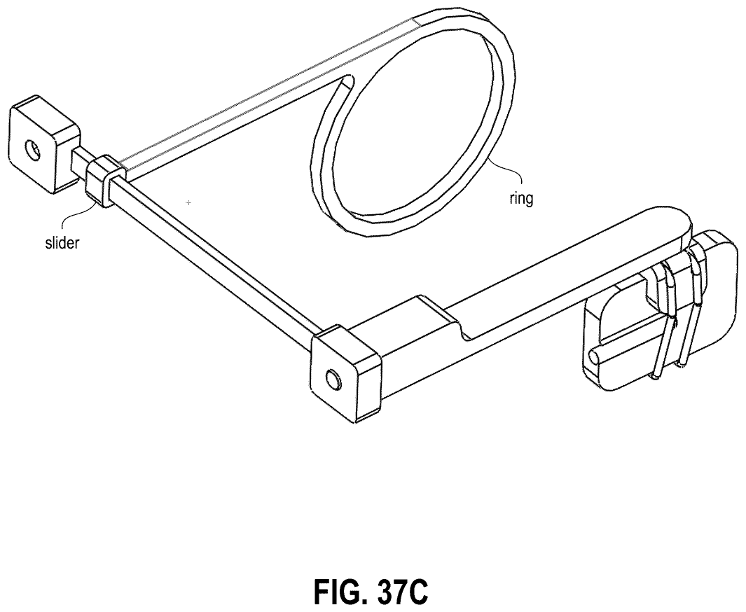

FIG. 37A is a perspective of a device for positioning a sensor inside an oral cavity of a patient, in accordance with another embodiment.

FIG. 37B is a front elevation view of the device as shown in FIG. 37A.

FIG. 37C is another perspective view of the device as shown in FIG. 37A.

As shown in FIGS. 37A-37C, the aiming portion is an aiming piece slidably engaged with the member to allow selective extraoral positioning, relative to the intraoral fitting, of the aiming portion along the ray. Unless otherwise provided for, as referred to herein extraoral end may refer to a location of the aiming portion outside the oral cavity or an intended location of the aiming portion outside the oral cavity, e.g. if the aiming portion is slidable, the extraoral end may be defined with respect to the location of the aiming portion subject to the aiming portion being outside the oral cavity. The intraoral fitting may be removably engaged or attached to the member, e.g. by a friction fit or other fastening means.

The intraoral fitting may include a lateral extension, e.g. a member, to laterally position a far end (relative to the member) of the intraoral fitting in oral cavity.

As shown in FIGS. 37A-37C, the member defines two intraoral attachment portions defining two locations where the intraoral fitting may be attached on to the member. The intraoral fitting may be removably attachable to any one of the two intraoral attachment portions to selectively facilitate extraoral location of the intraoral fitting through right and left facial sides. The intraoral attachment portions are configured to couple to the intraoral fitting via interference fits to form a joint between the member and the intraoral fitting. Allowing repositioning of the intraoral fitting from one side of the aiming portion to the opposite side of the aiming portion allows the device to be used on either side of the mouth. Such an advantage is achieved by changing the relative orientation between the aiming portion and the intraoral fitting to effectively switch (and consequently redefine) the intraoral and extraoral ends. As such, it is understood that, in some embodiments, the aiming portion may be moved instead of the intraoral fitting to switch the positions of the intraoral and extraoral ends.

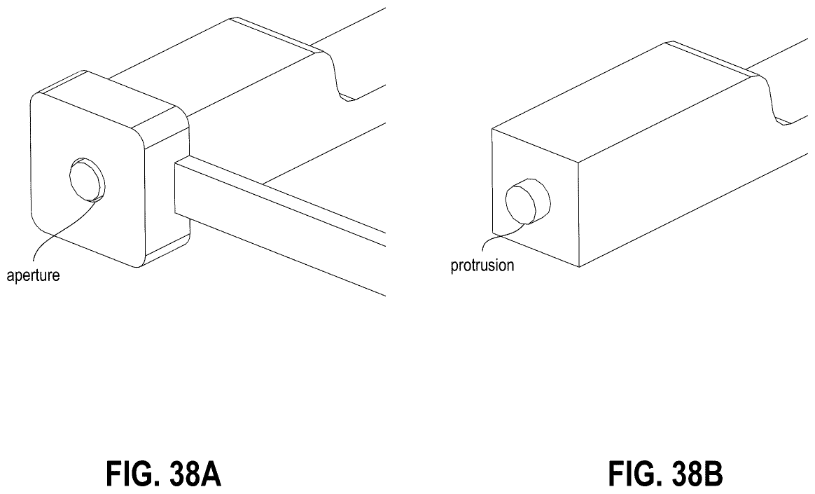

FIG. 38A is an enlarged perspective view of a joint of the device of FIG. 37A, in accordance with an embodiment.

FIG. 38B is an enlarged perspective view of a member of the device with a protrusion for forming the joint of FIG. 38A.

As shown in FIG. 38A, the attachment portion of the member has an aperture for receiving a (complementary) protrusion (shown in FIG. 38B) on the intraoral fitting to achieve a frictional and/or interference fit between the attachment portion of the member and the intraoral fitting. It is understood that, in some embodiments, the attachment portion may have a protrusion complementary to an aperture on the intraoral fitting.

The device embodiment shown in FIGS. 36A-36B may be particularly suited for imaging front teeth, while the device embodiment shown in FIGS. 37A-37C may be particularly suited for imaging side teeth. For example, having a slider (or slidable engagement of the aiming portion with the member) may be particularly advantageous for imaging side teeth, or at least more so than imaging front teeth. Unitary construction of the member with the aiming portion for a device intended for imaging front teeth may advantageously reduce device complexity and manufacturing cost.

As mentioned previously, the devices in FIGS. 36A-36B and FIGS. 37A-37C may be suitable for biting on. The biting portion is generally located on or proximal to the member in-between the aiming portion and the intraoral fitting, or generally in-between the intraoral end and the extraoral end. In some embodiments, the member be configured such that it is suitable for receiving biting teeth on distinctive portions of the member. For example, the distinctive portion may be a bite bar, such as a protrusion integral with or in unitary construction with the member or a monoblock movably engaged with the member. In some embodiments, a bite bar may be slidable engaged with, magnetically engaged with, clamped onto, and/or frictionally retained on the member. For example, the bite bar may be slidably engaged with the member via prismatic joint, or may be magnetically coupled to the member via built-in magnets in the bite bar and/or in the member. In some embodiments, the bite bar may be engaged with the member via a C-clamp.

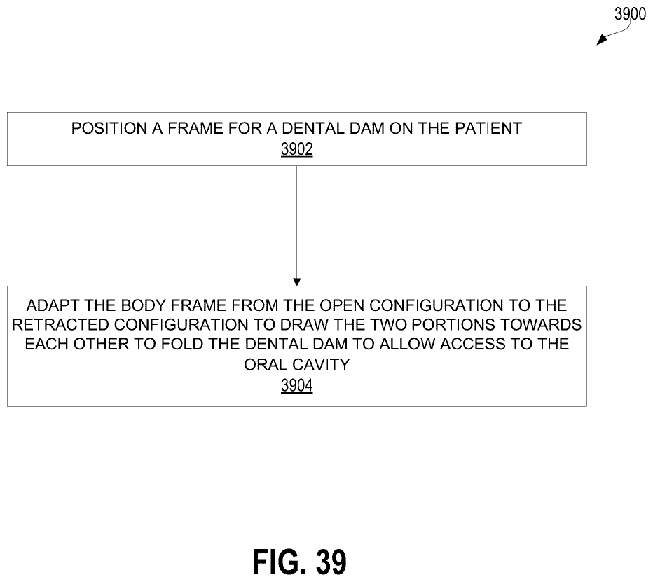

FIG. 39 is a flow chart of an exemplary method 3900 of accessing a patient's oral cavity during a dental procedure.

Step 3902 of the method 3900 includes positioning a frame for a dental dam on the patient, wherein a body of the frame is conformationally adaptable between open and retracted configurations, two portions of the body, situated at opposite sides of the body and engaged with the dental dam to facilitate the dental procedure, are splayed away from each other in the open configuration to spread out the dental dam to hinder access to the oral cavity.

Step 3904 of the method 3900 includes adapting the body frame from the open configuration to the retracted configuration to draw the two portions towards each other to fold the dental dam to allow access to the oral cavity.

Some embodiments of the method 3900 further comprise: anchoring the dental dam in the oral cavity (e.g. via an anchoring attachment placed on top of the dental dam and coupled to a tooth via a surgical cut-out in the dental dam), wherein step 3904 is executed while the dental dam is anchored in the oral cavity.

Some embodiments of the method 3900 further comprise: after step 3904, disposing a member suitable for biting by teeth in the oral cavity such that the member is held in-place at least partially in the oral cavity, the member elongated between intraoral and extraoral ends, and then after such a step, targeting, extraorally, electromagnetic radiation at a sensor held at the intraoral end by using an aiming portion at the extraoral end positioned complementarily to the sensor about the member.

In some embodiments of the method 3900, the body is elongated between the opposite sides from a first terminal end to a second terminal end, the second terminal end spaced apart from the first terminal end.

In some embodiments of the method 3900, wherein the first portion is a first piece defining the first terminal end and attached to a first part of the dental dam, and the second portion is a second piece defining the second terminal end and attached to a second part of the dental dam. Some embodiments of the method 3900 further comprise: rotating the first and second pieces relative to each other via a hinge of the body coupling the first piece to the second piece to retract the first part of the dental dam towards the second part of the dental dam to allow access to the oral cavity.

Some embodiments of the method 3900 further comprise: engaging a detent with the hinge to prevent rotation of the first and second pieces relative to each other.

In some embodiments of the method 3900, the detent is slidably engageable with the first piece to at least partially girdle the hinge to obstruct rotation of the first and second pieces about the hinge.

In some embodiments of the method 3900, the two portions include a first piece attached to a first part of the dental dam and a second piece attached to a second part of the dental dam, the first and second pieces independently hinged to an intermediate piece disposed between the first and second portions to permit the first and second parts of the dental dam to be selectively retracted towards each other. Some embodiments of the method 3900 further comprise: engaging a first detent with a first hinge coupling the first piece to the intermediate piece to prevent rotation of the first and intermediate pieces relative to each other; and while the first detent is engaged with the first hinge, rotating the second piece relative to the intermediate piece to retract the second part of the dental dam towards the first part of the dental dam to allow access to the oral cavity.

Some embodiments of the method 3900 further comprise: rotating the second piece relative to the intermediate piece to draw the second part of the dental dam away from the first part of the dental to hinder access to the oral cavity; and engaging a second detent with a second hinge coupling the second piece to the intermediate piece to prevent rotation of the second and intermediate pieces relative to each other.

In some embodiments of the method 3900, the first and second portions extend in a common plane and connect to each other in a plane that is offset from the common plane to facilitate fitting of the frame.

In some embodiments of the method 3900, the body includes a plurality of spikes extending outwardly therefrom to pierce and frictionally engage with the dental dam.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A frame for a dental dam, comprising:
a body defining two portions configured to engage with the dental dam and that are situated at opposite sides of the body, the body being conformationally adaptable between an open configuration and a retracted configuration such that the two portions are splayed away from each other in the open configuration to spread out the dental dam and are drawn towards each other in the retracted configuration to fold the dental dam.

2. The frame of claim 1, wherein the body is elongated between the opposite sides from a first terminal end to a second terminal end, the second terminal end spaced apart from the first terminal end.

3. The frame of claim 2, wherein the first portion is a first piece defining the first terminal end and attached to a first part of the dental dam, and the second portion is a second piece defining the second terminal end and attached to a second part of the dental dam, a hinge of the body coupling the first piece to the second piece to allow rotation of the first and second pieces relative to each other to allow retraction of the first and second parts of the dental dam over each other.

4. The frame of claim 3, wherein the body includes a detent selectively engageable with the hinge to prevent rotation of the first and second pieces relative to each other.

5. The frame of claim 4, wherein the detent is slidably engageable with the first piece to at least partially girdle the hinge to obstruct rotation of the first and second pieces about the hinge.

6. The frame of claim 1, wherein the two portions include a first portion attached to a first part of the dental dam and a second portion attached to a second part of the dental dam, the first and second portions attached to each other via an intermediate portion disposed between the first and second portions, the first and second portions being independently rotatable relative to the intermediate portion to permit the first and second parts of the dental dam to be selectively retracted towards each other.

7. The frame of claim 6, wherein the first portion is a first piece, the second portion is a second piece, and the intermediate portion is an intermediate piece, the first and second pieces being hinged at opposed ends of the intermediate portion to allow independent rotation of each of the first and second pieces about the intermediate piece.

8. The frame of claim 7, includes a first detent selectively engageable with a first hinge hinging the first piece to the intermediate piece to prevent rotation of the first and intermediate pieces about the first hinge, and a second detent selectively engageable with a second hinge hinging the second piece to the intermediate piece to prevent rotation of the second and intermediate pieces about the second hinge.

9. The frame of claim 1, wherein the first and second portions extend in a common plane and connect to each other in a plane that is offset from the common plane to facilitate fitting of the frame.

10. The frame of claim 1, wherein the body includes a plurality of spikes extending outwardly therefrom to pierce and frictionally engage with the dental dam.

11. A kit for use in a dental procedure to facilitate intraprocedural access to a patient's oral cavity, comprising:
a frame for a dental dam, the frame comprising:
a body defining two portions configured to engage with the dental dam and that are situated at opposite sides of the body, the body being conformationally adaptable between an open configuration and a retracted configuration such that the two portions are splayed away from each other in the open configuration to spread out the dental dam and are drawn towards each other in the retracted configuration to fold the dental dam, the body being mounted over the oral cavity such that the open configuration is suitable to hinder access to the oral cavity and the retracted configuration is suitable to allow access to the oral cavity.

12. The kit of claim 11, further comprising:
a device having
a member suitable for biting by teeth and elongated between an intraoral end and an extraoral end;
an intraoral fitting at the intraoral end; and
an aiming portion at the extraoral end that is positioned complementarily to the intraoral fitting about the member to facilitate extraoral targeting of the intraoral fitting.

13. The kit of claim 12, wherein the member is substantially linear, and the aiming portion is shaped to extend at least partially laterally from the member to define a reference plane and a reference locus in the reference plane such that a ray defined by the reference plane and the reference locus traverses the intraoral fitting.

14. The kit of claim 13, wherein the aiming portion is an aiming piece slidably engaged with the member to allow selective extraoral positioning, relative to the intraoral fitting, of the aiming portion along the ray.

15. The kit of claim 11, wherein the intraoral fitting includes a sensor holder and a sensor for dental imaging removably attached to the sensor holder.

16. The kit of claim 12, wherein the member defines two intraoral attachment portions, the intraoral fitting being removably attachable to any one of the two intraoral attachment portions to selectively facilitate extraoral location of the intraoral fitting through right and left facial sides.

17. The kit of claim 16, wherein the intraoral attachment portions are configured to couple to the intraoral fitting via interference fits.

18. A method of accessing a patient's oral cavity during a dental procedure, comprising:
(a) positioning a frame for a dental dam on the patient, a body of the frame being conformationally adaptable between open and retracted configurations, two portions of the body, situated at opposite sides of the body and engaged with the dental dam to facilitate the dental procedure, being splayed away from each other in the open configuration to spread out the dental dam to hinder access to the oral cavity; and
(b) adapting the body frame from the open configuration to the retracted configuration to draw the two portions towards each other to fold the dental dam to allow access to the oral cavity.

19. The method of claim 18, further comprising anchoring the dental dam in the oral cavity, wherein step (b) is executed while the dental dam is anchored in the oral cavity.

20. The method of claim 18, further comprising:
(c) after step (b), disposing a member suitable for biting by teeth in the oral cavity such that the member is held in-place at least partially in the oral cavity, the member elongated between intraoral and extraoral ends; and
(d) after step (c), targeting, extraorally, electromagnetic radiation at a sensor held at the intraoral end by using an aiming portion at the extraoral end positioned complementarily to the sensor about the member.

21. The method of claim 18, wherein the body is elongated between the opposite sides from a first terminal end to a second terminal end, the second terminal end spaced apart from the first terminal end.

22. The method of claim 21, wherein the first portion is a first piece defining the first terminal end and attached to a first part of the dental dam, and the second portion is a second piece defining the second terminal end and attached to a second part of the dental dam, the method further comprising:
rotating the first and second pieces relative to each other via a hinge of the body coupling the first piece to the second piece to retract the first part of the dental dam towards the second part of the dental dam to allow access to the oral cavity.

23. The method of claim 22, further comprising:
engaging a detent with the hinge to prevent rotation of the first and second pieces relative to each other.

24. The method of claim 23, wherein the detent is slidably engageable with the first piece to at least partially girdle the hinge to obstruct rotation of the first and second pieces about the hinge.

25. The method of claim 18, wherein the two portions include a first piece attached to a first part of the dental dam and a second piece attached to a second part of the dental dam, the first and second pieces independently hinged to an intermediate piece disposed between the first and second portions to permit the first and second parts of the dental dam to be selectively retracted towards each other, the method further comprising:
engaging a first detent with a first hinge coupling the first piece to the intermediate piece to prevent rotation of the first and intermediate pieces relative to each other; and
while the first detent is engaged with the first hinge, rotating the second piece relative to the intermediate piece to retract the second part of the dental dam towards the first part of the dental dam to allow access to the oral cavity.

26. The method of claim 25, further comprising:
rotating the second piece relative to the intermediate piece to draw the second part of the dental dam away from the first part of the dental to hinder access to the oral cavity; and
engaging a second detent with a second hinge coupling the second piece to the intermediate piece to prevent rotation of the second and intermediate pieces relative to each other.

27. The method of claim 18, wherein the first and second portions extend in a common plane and connect to each other in a plane that is offset from the common plane to facilitate fitting of the frame.

28. The method of claim 18, wherein the body includes a plurality of spikes extending outwardly therefrom to pierce and frictionally engage with the dental dam.
